(19) United States
(12) Patent Application Publication
(10) Pub. No.: US 2024/0135219 A1
(43) Pub. Date: Apr. 25, 2024

(54) ENHANCED SIGNAL PROCESSING USING QUANTUM COMPUTATION

(71) Applicants: Arizona Board of Regents on Behalf of the University of Arizona, Tucson, AZ (US); Duke University, Durham, NC (US)

(72) Inventors: Narayanan Rengaswamy, Durham, NC (US); Kaushik Seshadreesan, Tucson, AZ (US); Saikat Guha, Tucson, AZ (US); Henry Pfister, Durham, NC (US)

(73) Assignees: Arizona Board of Regents on Behalf of the University of Arizona, Tucson, AZ (US); Duke University, Durham, NC (US)

(21) Appl. No.: 18/273,344

(22) PCT Filed: Jan. 25, 2022
(86) PCT No.: PCT/US2022/013615

§ 371 Date: Jul. 20, 2023

Related U.S. Application Data
(60) Provisional application No. 63/141,187, filed on Jan. 25, 2021.

(51) Int. Cl. G06N 10/20

(52) U.S. Cl. CPC G06N 10/20

(57) ABSTRACT

A signal comprises a plurality of codewords associated with a set of codewords, each codeword comprising a plurality of symbols associated with a symbol constellation. Processing includes: mapping quantum states associated with symbols of a particular codeword of the signal to a plurality of input qubits, and applying quantum operations to the input qubits according to a quantum circuit for decoding the signal. The quantum operations comprise: controlled unitary multi-qubit operations performed on two or more qubits in a first set of qubits controlled based on two or more qubits in a second set of qubits, an initial quantum measurement performed on an initially measured qubit in the first set of qubits, at least one controlled unitary single-qubit operation performed on a post-measurement state associated with the initially measured qubit, and quantum operations that invert at least a portion of the operations in the plurality of controlled unitary multi-qubit operations.

### CROSS-REFERENCE TO RELATED APPLICATION(S)

This application claims priority to and the benefit of U.S. Provisional Application Patent Ser. No. 63/141,187, entitled “PROCESSING OPTICAL SIGNALS USING QUANTUM-ENHANCED COMMUNICATIONS,” filed Jan. 25, 2021, the entire disclosure of which is hereby incorporated by reference.

### STATEMENT AS TO FEDERALLY SPONSORED RESEARCH

This invention was made with government support under Grant Nos. 1855879, 1718494, 1908730, and 1910571, awarded by NSF and Grant No. N00014-14-1-0505, awarded by NAVY/ONR. The government has certain rights in the invention.

### TECHNICAL FIELD

This disclosure relates to enhanced signal processing using quantum computation.

### BACKGROUND

A classical-quantum channel can be used to model a form of communication in which inputs to the channel can be described as classical signals and outputs from the channel can be described as a certain type of quantum states (e.g., pure states). Some techniques for decoding signals sent over a classical-quantum channel can use decoding algorithms based on graphical models. One example of such a decoding scheme is described in Renes, J. M. “Belief propagation decoding of quantum channels by passing quantum messages,” New J. Phys. 19, 072001 (2017), incorporated herein by reference, also known as belief propagation with quantum messages (BPQM).

### SUMMARY

In one aspect, in general, a method for processing a signal comprising a plurality of codewords associated with a set of codewords, each codeword comprising a plurality of symbols associated with a symbol constellation, includes: mapping quantum states associated with symbols of a particular codeword of the signal to a plurality of input qubits; and applying quantum operations to the input qubits according to a quantum circuit for decoding the signal. The quantum operations comprise: a plurality of controlled unitary multi-qubit operations performed on two or more qubits in a first set of qubits controlled based on two or more qubits in a second set of qubits, an initial quantum measurement performed on an initially measured qubit in the first set of qubits, at least one controlled unitary single-qubit operation performed on a post-measurement state associated with the initially measured qubit, and a plurality of quantum operations that invert at least a portion of the operations in the plurality of controlled unitary multi-qubit operations.

In other aspects, in general, one or more non-transitory machine-readable media comprise instructions that, when executed by a system comprising a quantum processor, cause the system to perform operations described herein, or an apparatus including a signal interface and quantum processor is configured to perform the operations described herein.

Aspects can include one or more of the following features.

The controlled unitary single-qubit operation performed on the post-measurement state associated with the initially measured qubit is controlled based on at least two of the qubits in the second set of qubits.

The controlled unitary single-qubit operation applies one of two potential rotations that is determined based at least in part on a result of the initial quantum measurement.

The plurality of quantum operations that invert at least a portion of the operations in the plurality of controlled unitary multi-qubit operations operate on a result of the controlled unitary single-qubit operation.

The plurality of controlled unitary multi-qubit operations include a first unitary multi-qubit operation that operates on all of the two or more qubits except for the initially measured qubit in the first set of qubits, and the quantum operations that invert at least a portion of the operations in the plurality of controlled unitary multi-qubit operations include a second unitary multi-qubit operation that operates on the same qubits as the first unitary multi-qubit operation.

The second unitary multi-qubit operation corresponds to a Hermitian adjoint of the first unitary multi-qubit operation.

The method further comprises a plurality of multi-qubit operations performed on two or more qubits in a third set of qubits that includes qubits from the first and second sets of qubits, after the plurality of quantum operations that invert at least a portion of the operations in the plurality of controlled unitary multi-qubit operations.

The method further comprises a plurality of quantum measurements performed on two or more qubits other than the initially measured qubit to provide information used for decoding the particular codeword of the signal.

The method further comprises generating the quantum circuit based at least in part on the set of codewords.

The initial quantum measurement comprises a quantum nondemolition measurement that determines information from the initially measured qubit and propagates the post-measurement state associated with the initially measured qubit after the quantum nondemolition measurement.

The initial quantum measurement comprises a destructive measurement that determines classical information from the initially measured qubit and prepares a quantum state of an ancilla qubit based on the classical information to provide the post-measurement state associated with the initially measured qubit.

All of the input qubits mapped from the quantum states associated with the symbols of the particular codeword of the signal are stored before any of the quantum operations are applied to the input qubits.

Information used for decoding the particular codeword of the signal is provided from the quantum operations before any quantum operations are applied to any input qubits mapped from quantum states associated with symbols of any codeword received from the signal after the particular codeword was received.

Mapping the quantum states associated with symbols of the particular codeword of the signal to the plurality of input qubits comprises converting optical qubits to qubits represented by a quantum state of a trapped atom or ion, or a quantum state of a superconducting circuit, or a nitrogen-vacancy center.

The optical qubits comprise output photons that result from nonlinear optical interactions between a first set of input photons included in the signal and a second set of input photons received from an entangled photon pair source.

The first set of input photons were derived from photons received from the entangled photon pair source before being encoded as symbols of the particular codeword of the signal.

The particular codeword is associated with a factor graph and the quantum circuit is arranged to perform a belief propagation procedure for decoding the particular codeword of the signal.

The belief propagation procedure includes quantum message passing implemented using the quantum circuit.

The belief propagation procedure includes reducing the factor graph into one or more disjoint factor graphs resulting from parity checks associated with the symbol constellation.

The signal interface is configured to receive the quantum states from an optical communications channel.

The optical communications channel comprises an optical fiber.

The signal interface is configured to receive the quantum states from a quantum register that is coupled to a control module that is configured to apply quantum gate operations among quantum states stored in the quantum register.

Aspects can have one or more of the following advantages.

A variety of forms of systems can be modeled using a classical-quantum channel. For communications systems, such as a space-based laser communications system, when the mean photon number per received optical pulse is much smaller than one, there is potentially a large gap between communications capacity achievable with a receiver that performs individual pulse-by-pulse detection, and the quantum-optimal “joint-detection receiver” that acts collectively on long codeword-blocks of modulated pulses; an effect often termed “superadditive capacity.” The techniques described herein are able to achieve such performance gains using a type of quantum-enhanced communications that executes a particular type of quantum circuit on a quantum processor to decode an incoming optical signal that has been modulated according to a particular symbol constellation. For example, some of the implementations described herein use binary phase-shift keyed (BPSK) modulation. Other implementations can use other modulation schemes, which may achieve further performance enhancement in some communication regimes. The particular type of quantum circuit includes a particular type of configuration of quantum operations, as described in more detail below, and can be supplied as input to a universal quantum computing system (e.g., a trapped-ion or superconducting qubit gate-based quantum processor, or a photonic quantum computer capable of performing cat-basis universal qubit logic), or can be incorporated into the hardware of a quantum processor that is not necessarily a universal quantum computing system. Some implementations are able to achieve a quantum limit of minimum average error probability. Without intending to be bound by theory, some examples below describe theoretical performance simulations and limits that illustrate some of the advantages of certain implementations.

Other features and advantages will become apparent from the following description, and from the figures and claims.

### BRIEF DESCRIPTION OF THE DRAWINGS

The disclosure is best understood from the following detailed description when read in conjunction with the accompanying drawing. It is emphasized that, according to common practice, the various features of the drawing are not to-scale. On the contrary, the dimensions of the various features are arbitrarily expanded or reduced for clarity.

FIG. 1A is a schematic diagram of an example quantum-enhanced processing system.

FIG. 1B is a schematic diagram of an example entanglement-assisted communications system.

FIG. 1C is a schematic diagram of an example quantum computing system.

FIG. 2 is a factor graph for the 5-bit linear code.

FIG. 3A is a plot of the overall block error rate of BPQM along with those of optimal joint Helstrom, symbol-by-symbol Helstrom followed by classical optimal block-MAP, and symbol-by-symbol Helstrom followed by classical BP.

FIG. 3B is a plot of the mutual information per photon per channel use achieved by BPQM and the Square Root Measurement (SRM) on the 5-bit code over the pure-state channel, along with the Holevo capacity of the channel and the BSC capacity induced by symbol-by-symbol Helstrom measurements at the channel output, all plotted against the mean photon number per mode (N).

FIG. 4 is a quantum circuit diagram of an example of a BPQM circuit to decode bit 1 of the 5-bit code in FIG. 2.

FIG. 5A is a schematic diagram illustrating how channel combining at a variable node (VN) using the induced channels at the node.

FIG. 5B is a schematic diagram illustrating how channel combining at a factor node (FN) using the induced channels at the node.

FIG. 6 is a reduced factor graph after estimating bit 1 to be \hat{x}₁.

FIG. 7 is a quantum circuit diagram of an example of a full BPQM circuit to decode all bits of the 5-bit code in FIG. 2.

FIG. 8A is a quantum circuit diagram of an example of the circuit decomposition for [symbol] (θ, θ′).

FIG. 8B is a set of quantum circuit diagrams of examples of the decompositions of controlled gates using Toffoli (or CCZ) gates and an ancilla bit.

FIG. 9 is a quantum circuit diagram of an example of the full decomposition of the BPQM circuit in FIG. 7. The variable node unitaries [symbol] (θ, θ′) are decomposed in FIG. 8A. The two-qubit-controlled coherent versions of these unitaries as well as the single-qubit rotation Kₘ_{₁}, which is a function of the measurement result m₁, are decomposed in FIG. 8B.

### DETAILED DESCRIPTION

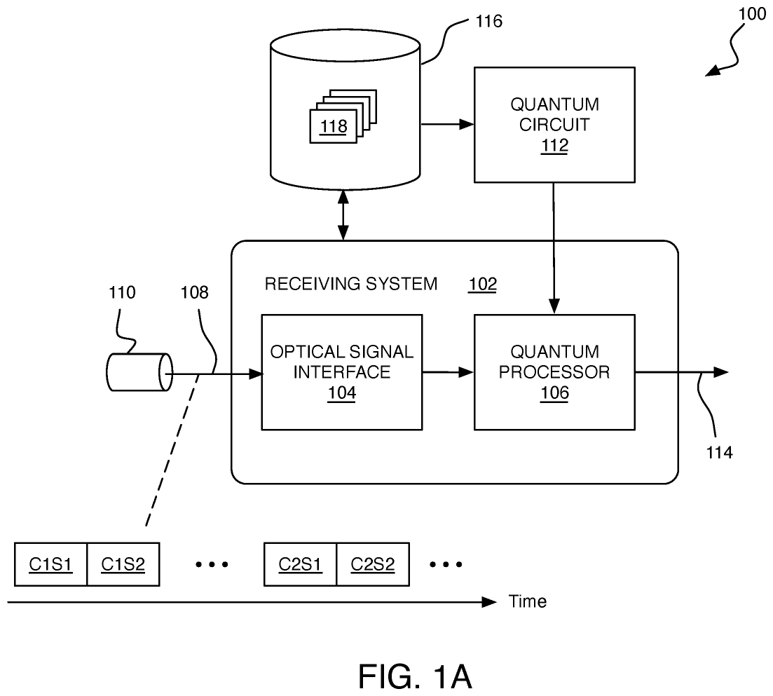

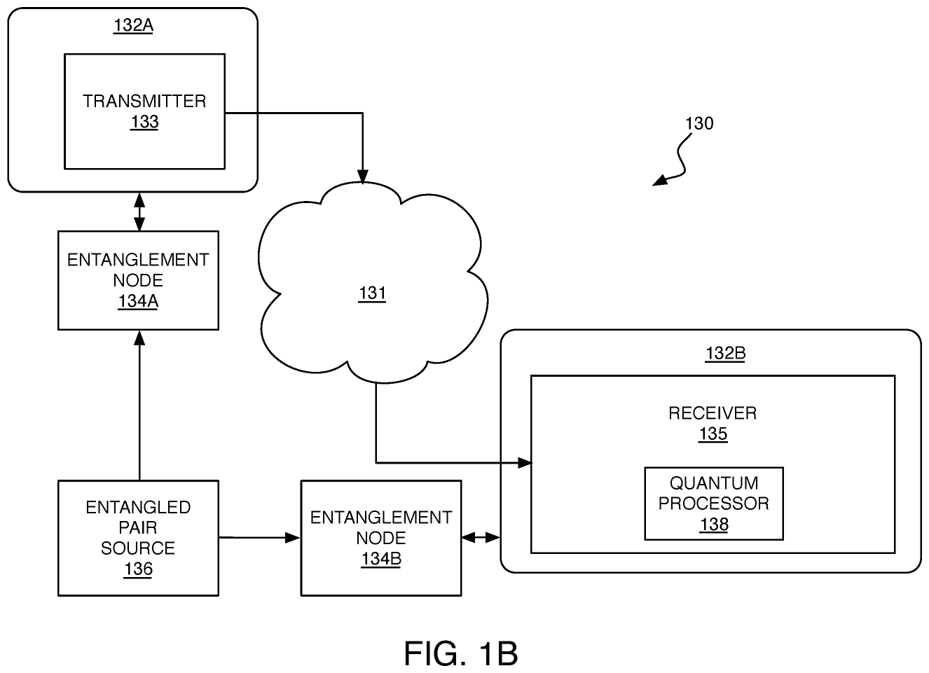

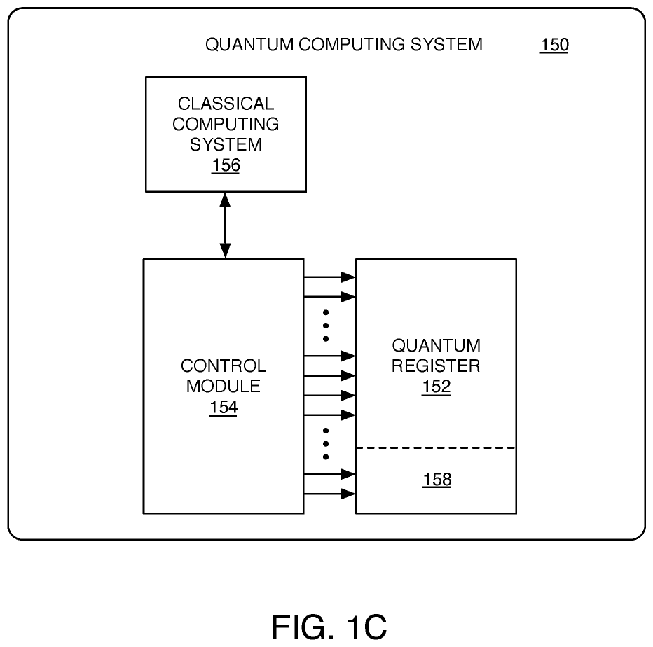

Referring to FIG. 1A, an example of a quantum-enhanced processing system 100 includes a receiving system 102 that includes an optical signal interface 104 and a quantum processor 106. The optical signal interface 104 receives an optical signal 108 that comprises a plurality of codewords from an optical channel interface. Each codeword has been selected from a predetermined code (i.e., a predetermined set of codewords), and each codeword comprises multiple symbols, where the different possible symbols that can appear in a codeword are from an associated symbol constellation corresponding to coherent optical modulation. The optical channel interface 110 may be different for different types of optical channels that may be used. For example, for an optical fiber-based communications channel, the optical channel interface 110 can include a fiber coupler. For a free-space optical communications channel, the optical channel interface 110 can include an aperture and optical elements (e.g., lenses) for receiving an optical beam. The optical signal interface 104 may be configured to include any of a variety of coherent optical receiver elements that mix the optical signal 108 with a coherent local oscillator optical signal. In this way, the output from the optical channel interface 110 provides, for a predetermined symbol time slot, a quantum state corresponding to a coherently modulated optical symbol. A corresponding sending system may perform the phase and amplitude modulation according to the symbol constellation using a laser and appropriate optical modulation and transmission devices, for example. In other examples the optical signal interface 104 can be replaced with a signal interface for other kinds of signals that provides symbols encoding quantum states (e.g., quantum states encoded in atoms, or electromagnetic waves other than optical waves).

In some implementations, these quantum states corresponding to the symbols are not immediately detected, or measured in any way, but are mapped to states of input qubits (also called a “code qubit”) for the quantum processor 106. In some implementations, mapping these quantum states to input qubits may include converting an optical qubit to another form of qubit stored in a particular kind of qubit storage element (e.g., a trapped atom or ion, a superconducting circuit, or a nitrogen-vacancy center). In other implementations, no conversion is needed, and the optical qubits can be operated upon using a form of optical quantum operations (e.g., using a cat-basis logic). In this example, there are a sequence of symbols C1S1, C1S2, . . . that make up a first codeword (C1), and a sequence of symbols C2S1, C2S2, . . . that make up a second codeword (C2), and so on, in a series of codewords that make up a signal waveform of the optical signal 108. The quantum processor 106 then applies quantum operations, as described herein, according to a particular quantum circuit 112 to yield decoded information 114. For example, the quantum circuit 112 may be loaded into the quantum processor 106 from a collection of configuration information 118 stored in a machine-readable storage device 116 (e.g., volatile or non-volatile storage media of a computer system controlling the receiving system 102).

In some implementations, one scenario where a relatively large superadditive capacity can be achieved is a pure-loss channel with a coherent-state binary phase-shift keyed (BPSK) modulation. The two BPSK states can be mapped conceptually to two non-orthogonal states of a qubit, described by an inner product that is a function of the mean photon number per pulse. Using this map, an explicit construction of an example quantum circuit for a joint-detection receiver to apply some of the BPQM techniques is described below.

Since the quantum circuit can be relatively small for a set of relatively short codewords, a relatively small quantum processor can be used (e.g., without requiring a large number of qubits). Thus, the quantum-enhanced communication may be appropriate for near term (e.g., NISQ) quantum devices. In this way, classical data can be reliably encoded using optical signals at or near the quantum-limited highest possible rate. Systems that use these techniques may include laser communication systems that operate in the low received photon flux regime (e.g., in deep space applications), or entanglement assisted classical communications systems that operate in the low transmitter-brightness, high-noise regime.

For example, in a communication system that can be used for space-based data communications can be configured to discriminate among different codewords that are formed using a series of modulated laser pulses. Discrimination of the codewords at a low probability of error can be achieved using a quantum processor (e.g., a universal gate-based quantum processor). A transmitter (e.g., on a satellite or a deep-space device) can include a laser that provides a series of laser pulses (e.g., an optical or rf electromagnetic wave having a default phase under an amplitude envelope) and a modulator that applies different phase shifts to the electromagnetic wave of different respective pulses. A receiver (e.g., on Earth) includes an interface and an interface and a quantum processor (e.g., trapped-ion quantum processor, a superconducting circuit quantum processor, a neutral atom quantum processor, or a photonic quantum processor). Depending on the type of quantum processor used, there may be different capabilities, such as all-to-all connectivity among quantum elements, and/or mid-circuit measurement capabilities. In some cases, the system uses joint-detection among over multiple pulses of a codeword to surpasses a quantum limit on the minimum average decoding error probability associated with pulse-by-pulse detection in the low mean photon number limit. For a trapped-ion quantum processor with all-to-all connectivity among quantum elements, and mid-circuit measurement capability, a joint-detection scheme bridges across photonic and trapped-ion based quantum information science, mapping the photonic coherent states of the modulation alphabet onto inner product-preserving states of single-ion qubits. Such systems have applications in astronomy and emerging space-based platforms.

Alternatively, the techniques described herein can be used for other types of communication systems (e.g., entanglement-assisted classical communications), or for computing systems (e.g., quantum computing systems or hybrid classical-quantum computing systems).

FIG. 1B shows an example of an entanglement-assisted communications system 130 that includes a first node 132A and a second node 132B in communication over a network 131 that includes both classical and quantum communication channels. The first node 132A includes a transmitter 133 that sends data encoded on a stream of codewords that are encoded based in part on quantum states from a first entanglement node 134A in proximity to first node 132A. The second node 132B includes a receiver 135 that decodes the stream of codewords based in part on quantum states from a second entanglement node 134B in proximity to the second node 132B. The entanglement nodes 134A and 134B can be configured to receive pre-shared entangled quantum states from an entangled pair source 136 (e.g., a source of entangled photon pairs based on spontaneous parametric downconversion). The entangled quantum states can be provided from the entangled pair source 136 as photons (e.g., a polarization state of photons), transmitted over quantum channels (e.g., channels in the network 131, or dedicated channels outside the network 131), and stored in the entanglement nodes 134A and 134B in any of a variety of forms of stored quantum states (e.g., quantum states of photons in a storage loop or ions in an ion trap). The entangled pair source 136 can be located in or near the first node 132A, in or near the second node 132B, or somewhere between them. A series of quantum states associated with a given codeword can be combined with a series of stored quantum states (e.g., using sum-frequency generation or other nonlinear optical processes) yielding quantum states that are supplied to a quantum processor 138 that is part of the receiver 135. The techniques described herein can be used to execute a quantum circuit on the quantum processor 138 to perform belief propagation, as described herein, to implement entanglement-assisted communication. In some implementations, each node 132A an 132B is configured as a transceiver that includes both the transmitter and receiver functionality described herein.

FIG. 1C shows an example of a quantum computing system 150 that includes a quantum register 152 storing multiple qubits in qubit storage elements that have some interconnection topology enabling multiple-qubit operations among quantum states stored in different qubit storage elements. In some implementations, the quantum computing system 150 is a photonic quantum computing system where the qubit storage elements correspond to photons propagating within an optical device (e.g., a photonic integrated circuit, one or more optical fibers, or other photonic storage mechanism). In such a photonic computing implementation, the quantum states in the quantum register 152 may correspond to optical cat states, or other squeezed states of light. Alternatively, another kind of quantum computing system can use a superconducting circuit (e.g., based on Josephson junctions), or charged ions, neutral atoms or other types of storage elements. A control module 154 applies different quantum gates to a series of quantum states stored in the quantum register 152 according to a quantum circuit representing a quantum program provided by a classical computing system 156. For example, in some implementations, the classical computing system 156 determines a series of pulses that are applied using the control module 154. In addition to stored quantum states that represent the qubits being used in the quantum program's quantum circuit, a subset of quantum storage elements 158 within the quantum register 152 can be reserved for use in executing a quantum circuit that performs belief propagation to enhance operation of the quantum computing system 150. For example, qubits in the storage elements 158 can be a set of ancilla qubits that are used to perform belief propagation, as described herein, for error correction or mitigation, and/or other functions of the quantum computing system 150.

“Message-passing” algorithms are used to efficiently evaluate quantities of interest in problems defined on graphs. They work by passing messages between nodes of the graph. For example, these algorithms have been successfully used for statistical inference, optimization, constraint-satisfaction problems and the graph isomorphism problem among several other applications. In particular, “belief-propagation” (BP) is a message-passing algorithm for efficiently marginalizing joint probability density functions in statistical inference problems. The algorithm derives its name from the fact that the messages used in BP are “local” probabilities or “beliefs” (e.g., of the value of the final quantity of interest). An example application of BP lies in the decoding of linear codes using the posterior bit-wise marginals given the outputs of a classical channel. It is well-known that BP exactly performs the task of optimal bit-wise maximum-a-posteriori (bit-MAP) decoding when the code's factor graph (FG) is a tree. However, since codes with tree factor graphs have poor minimum distance, BP is also applied to codes whose factor graphs have cycles, e.g, low-density parity-check (LDPC) codes. Although BP does not compute the exact marginals in this case, it is computationally more efficient than MAP, and usually performs quite well. In fact, it has been proven that, for large blocks, BP achieves the optimal MAP performance for spatially-coupled LDPC codes over the binary erasure channel and binary memoryless symmetric channels. From a more practical perspective, BP-based decoders are routinely deployed in modern communications and data storage.

Given the success of BP decoding for classical channels, it is natural to ask if it can be generalized to the quantum setting. For example, can one decode classical codes for communications over a classical-quantum channel or, more generally, perform efficient inference on graphically-represented classical data encoded in qubits? Consider laser communications based on binary-phase-shift-keying (BPSK) modulation for sending classical data over a pure-loss bosonic channel of transmissivity η∈(0, 1]. During each “use” of the quantum channel, the transmitter modulates each optical pulse, or mode, into one of the two coherent states |α [symbol] or |−α [symbol] , where α∈ [symbol] and the mean photon number per mode equals N_{S}=|α|². Each channel output symbol is an optical pulse that is in one of the two coherent states |±β [symbol] , where β=\sqrt{η}α and mean photon number N=ηN_{S}. These two states are non-orthogonal with an inner product [symbol] β|−β [symbol] =e^{-2N}≡σ. In this case, the coherent states

$$\vert \pm β 〉 = {\sum }_{n = 0}^{∞} {e}^{- {\vert β \vert}^{2} / 2} \frac{{( \pm β )}^{n}}{\sqrt{n !}} \vert n 〉$$

live in an infinite-dimensional Hilbert space spanned by the complete orthonormal number basis {|n [symbol] , n∈ [symbol] }. However, since each channel output is always in one |±β [symbol] , for the purposes of designing a receiver, we can embed the subspace spanned by |±βϵ in a two-dimensional (qubit) Hilbert space via the inner-product-preserving map:

|±β [symbol] [symbol] |±θ [symbol] :=cosθ/2|0 [symbol] ±sinθ/2|1 [symbol] , (1)

with σ=cosθ. The resulting channel from a classical encoding variable x to a conditional quantum state, i.e., [x=0] [symbol] |θ [symbol] , [x=1] [symbol] |−θ [symbol] , is often called a (pure-state) “classical-quantum” (CQ) channel in the quantum information theory literature.

When the channel output symbols are detected one at a time, the best possible detection error probability is given by the Helstrom bound on the minimum average error probability of discriminating the alphabet states |±β [symbol] , which is p:=½[1−\sqrt{1−σ²}]. A structured optical design of a receiver that achieves this performance was invented by Dolinar in 1973. This receiver induces a binary symmetric channel (BSC) between the quantum channel outputs |±β [symbol] and the receiver's guess “±β”, with crossover probability p, thereby enabling the communicating parties to achieve a reliable communication rate given by C₁=1−h₂(p) bits per mode, the Shannon capacity of the BSC. To achieve communication at a rate close to this capacity, one would need to use a code that achieves the Shannon capacity of the BSC, e.g., a polar code, and a suitable decoder. If the receiver detects, i.e., converts from the quantum (optical) to the electrical domain, each quantum channel output one at a time, no amount of classical post-processing, including feedforward between channel uses, and soft-information processing, can achieve a rate higher than C₁. Thus, a capacity-approaching LDPC code for the BSC and a BP decoder can approach but not surpass the rate C₁.

However, if one employs a quantum joint-detection receiver that collectively measures the entire block of n channel outputs, then the rate may increase to the Holevo limit, C_{∞}=S(½|β [symbol] [symbol] β|+½|−β [symbol] [symbol] −β|)=h₂([1+ρ]/2) bits per mode, where S(⋅) denotes the von Neumann entropy. In the limit as N→0 (or equivalently σ→1), where the mean photon number per mode vanishes, one can show that C_{∞}/C₁→∞ and collective measurement is preferable. This regime of operation can be useful for long-haul free-space terrestrial and deep-space laser communications. In order to fully exploit this large capacity gain, one can use a CQ polar code with a decoder based on collective measurement of the received quantum state.

Alternatively, one can use a codebook comprising M=2^{nR} random length-n codewords with R<C_{∞}, where each symbol of each codeword is chosen from an equal prior over the two BPSK symbols. If the receiver employs a joint measurement that discriminates between the codewords sufficiently well, then the probability of decoding error will converge to 0 as n→∞. Both the optimal measurement and the square-root measurement (SRM) are known to faithfully discriminate between roughly 2^{nC∞} codewords, as opposed to only 2^{nC}^{₁} codewords if symbol-by-symbol detection is combined with classical decoding. Given the quantum states of the M codewords, the optimal measurement can be computed by applying the Yuen-Kennedy-Lax (YKL) conditions applied to the Gram matrix of the codebook—the M-by-M matrix of pairwise inner products of the codewords' quantum states. This calculation is simpler for linear codes, especially codes that have certain group symmetries. Even when it is possible to compute the optimal measurement for the codebook, it may be hard to translate the mathematical description into a physical receiver design, unless we have a general-purpose photonic quantum computer. Therefore, an efficient and physically-realizable receiver is of significant practical interest if it can outperform the optimal receiver based on optimal symbol-by-symbol measurement.

BPQM provides a quantum generalization of BP for a binary-output pure-state CQ channel. BPQM is well-defined on a tree factor graph and works by passing quantum messages (encoded in qubits) and classical messages (bits) between nodes of the code's factor graph. Unlike earlier algorithms termed “quantum belief-propagation”, BPQM does not measure the n channel outputs, followed by classical BP on the (classical) syndrome measurements, and hence is not limited to achieving a rate of C₁. In BPQM, the message-combining operations in classical BP are interpreted as “channel combining” rules that execute a local inference procedure. Additionally, BPQM provides a generalization of these channel combining rules to allow for quantum messages, as in CQ polar codes, i.e., messages that are qubit density matrices which capture the node's belief about a message bit. The above rules define a CQ channel that gets induced at each node when (quantum) messages arrive at it. Finally, BPQM defines appropriate unitary operations at the nodes, which process the outputs of the aforesaid induced CQ channels and produce messages to be passed on to subsequent nodes.

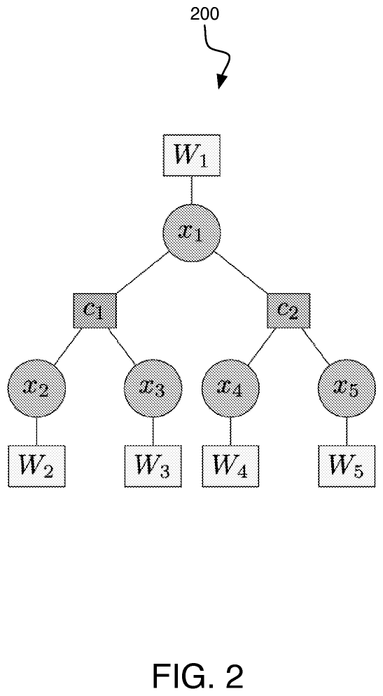

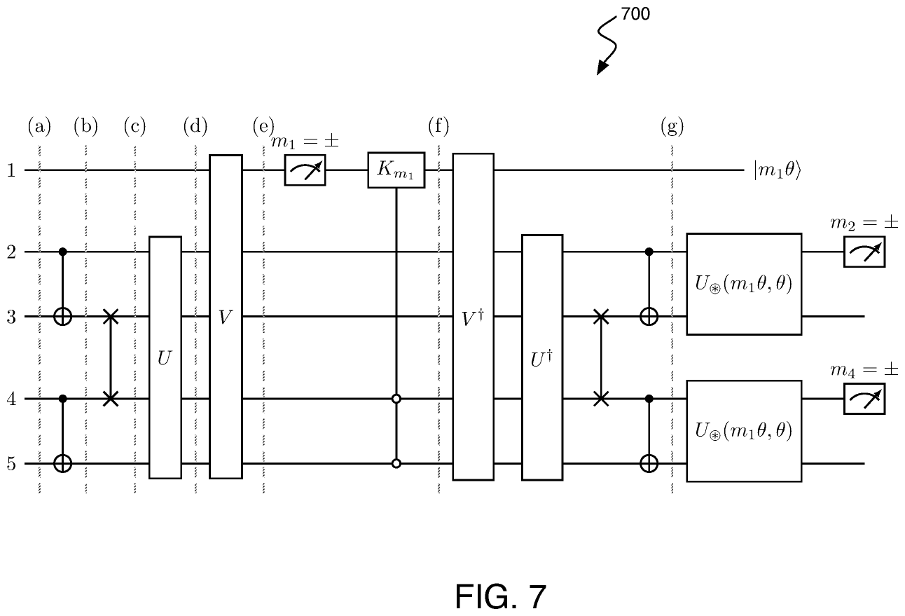

We describe an example herein of an explicit quantum circuit (e.g., used as the quantum circuit 112) for a BPQM-based joint-detection receiver (for an example blueprint, see FIG. 7), and prove that it achieves the Helstrom limit for discriminating between the 8 codewords in our exemplary n=5 linear BPSK code with a tree factor graph, as shown in FIG. 2. Hence, it outperforms the best achievable performance by the optimal symbol-by-symbol receiver measurement followed by a MAP decision.

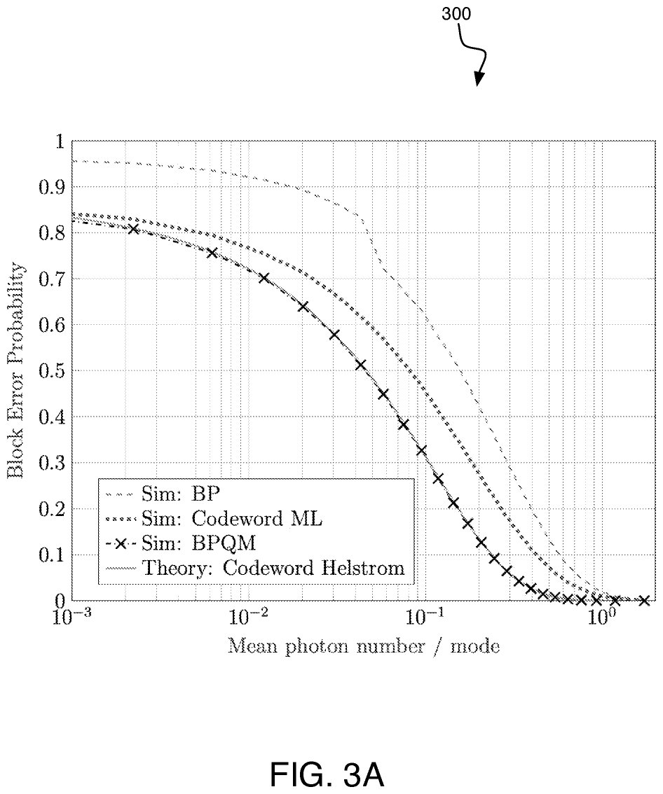

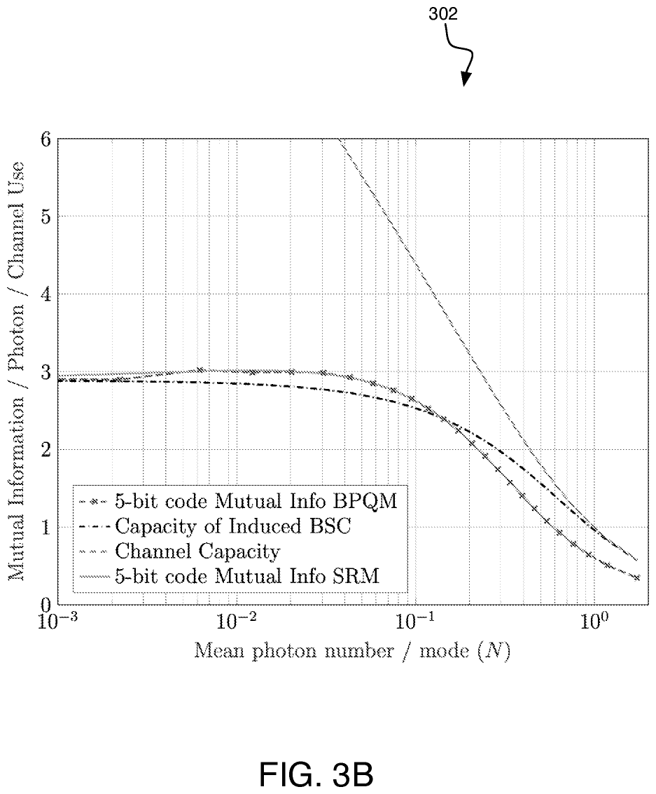

Based on our analysis of BPQM, we introduce a coherent rotation to be performed after decoding bit 1 as part of an example receiver design, which is not part of the basic BPQM algorithm. This is useful for generalizing BPQM beyond the specific example considered here. We explicitly compute the density matrices of quantum messages that are passed, and evaluate the performance of BPQM for this example code. For decoding bit 1, we also derive an analytical expression for the BPQM success probability. The ultimate benchmark for decoding a bit is the performance of the Helstrom measurement that optimally distinguishes the density matrices corresponding to the two values of the bit. We show that BPQM is optimal for deciding the value of each of the 5 bits. In FIG. 3A, we plot performance curves that show the “global” performance of BPQM for the 5-bit code in terms of block (codeword) error rate for the following strategies:
(a) collective (optimal) Helstrom measurement on all n=5 channel outputs of the received codeword,
(b) BPQM on all channel outputs of the received codeword,
(c) symbol-by-symbol (optimal) Helstrom measurement followed by classical (optimal) block-MAP decoding, and
(d) symbol-by-symbol (optimal) Helstrom measurement followed by classical BP decoding. For the last two schemes, classical decoding is performed for the BSC, with crossover probability p=½[1−\sqrt{1−σ²}], that is induced by measuring each channel output with the Helstrom measurement to discriminate between |±θ [symbol] .

As expected, the block error probabilities are in increasing order from (a) through (d). FIG. 3A shows that BPQM is strictly better than the quantum-optimal symbol-by-symbol detection followed by a block-MAP decision at all values of mean photon number per mode, and that it meets the optimal joint Helstrom measurement on the modulated codeword. We confirm this optimality analytically by using the fact that the square root measurement (SRM), also called the pretty good measurement (PGM), is optimal for transmitting binary linear codes on the pure-state channel. More precisely, we calculate the closed-form expression for the SRM block error probability, in terms of the classical code and associated cosets, and the density-matrix based expression for the BPQM block error probability for this example code. Then, for a range of channel parameters we compute the values from these expressions and confirm that they agree up to even 15 decimal places. Therefore, while decomposing the SRM itself into an explicit circuit might be challenging, BPQM provides a circuit that still achieves the optimal block error probability for this code. This is a useful result because it demonstrates that if we can construct a BPQM receiver, then it will outperform any known physically realizable receiver for this channel.

Besides the block error rates, we also compare the mutual information-per-photon-per-channel-use, also referred to as the photon information efficiency (PIE), for BPQM, with the Holevo capacity of the pure-state channel and the capacity induced by symbol-by-symbol Helstrom measurements. In order to do this, we consider a composite channel whose input is k=3 bits and output is also k=3 bits, where the channel consists of encoding into the 5-bit code, transmitting over the pure-state channel, applying the BPQM receiver and identifying the transmitted codeword (equivalently the k-bit message).

Determining the PIE for the BPQM analytically involves calculating closed form expressions for the transition probabilities of the 2^{k}-ary channel (where k=3 for the considered 5-bit code), which involves cumbersome calculations of the relevant density matrices. Instead, we calculate the PIE numerically by performing a Monte Carlo simulation. FIG. 3B shows a plot of the PIE of the BPQM receiver along with those corresponding to the Holevo capacity and the symbol-by-symbol Helstrom induced BSC capacity. We also compute the PIE for the square root measurement (SRM). The transition probability of decoding a transmitted message t∈{0, 1}^{k} as g∈{0, 1}^{k} using the SRM is given by

$$ℙ [ g \vert t ] = \frac{{\hat{σ} ( g ⊕ t )}^{2}}{{2}^{k}} , \\ \hat{σ} ( g ⊕ t ) = \frac{1}{\sqrt{{2}^{k}}} {\sum }_{h ∈ {ℤ}_{2}^{k}} {( - 1 )}^{{h ( g ⊕ t )}^{T}} σ ( h ) , σ ( h ) = {2}^{k / 4} \sqrt{\hat{s} ( h )} , \qquad ( 2 )$$

where ŝ(h) is as defined in (132).

Therefore, the transition probability only depends on the sum g⊕t and hence the channel is symmetric. Using this closed form expression, we compute the mutual information for this k-bit channel, normalized by n=5 (to obtain mutual information per channel use), then normalized by N to obtain the PIE, and also plot it in FIG. 3B. We see that both BPQM and SRM produce identical curves, just as they do in block error rates. Finally, we observe that there exists a regime of N, where this explicit small code along with BPQM or SRM demonstrates superadditive capacity that beats the largest PIE obtained from symbol-by-symbol Helstrom measurements. The PIE with the BPQM (or SRM) receiver is found to be maximized at N=6.2×10⁻³, the maximum PIE being 3.021, whereas the corresponding PIE attained by symbol-by-symbol Helstrom measurements is 2.862, the ratio of the two numbers being 1.056. The superadditive PIE hence makes the case stronger for performing the optimal collective measurement at the channel output using the systematic scheme of BPQM.

In FIG. 3A, we had plotted the block error probabilities as a function of the mean photon number per mode for the different measurement strategies. We calculated both the bit and block error probabilities (and success probabilities, i.e., one minus error probability) for these measurement strategies. For strategy (a), the performance of the collective Helstrom measurement is plotted using the Yuen-Kennedy-Lax (YKL) conditions. For strategies (c) and (d), classical processing is performed essentially for the BSC induced by measuring each qubit output by the pure-state channel. The mean photon number per mode, N, relates to the pure-state channel parameter θ as cosθ=e^{-2N}. We make the following observations from these calculations.
1. The block error rates are in increasing order from strategy (a) to (d), as we might expect. Even though classical BP is performed on a tree FG here, it only implements bit-MAP decoding and not block-MAP decoding. This is why it performs worse than block-ML (i.e., block-MAP with uniform prior on codewords) in this case.
2. BPQM performs strictly better than symbol-by-symbol optimal detection followed by classical MAP decoding. This gives a clear demonstration that if one physically constructs a receiver for BPQM, then it will be the best known physically realizable receiver for the pure-state channel. For example, the Dolinar receiver realizes only strategy (c). One can use our circuits to make such a physical realization.
3. BPQM performs as well as the quantum optimal collective Helstrom measurement on the outputs of the channel. This lends evidence to the conclusion that by passing quantum messages, BPQM is able to behave like a collective measurement while still making only single-qubit Pauli measurements during the process. However, more careful analysis is required to characterize this in general for, say, the family of codes with tree FGs.
4. As a first self-consistency check, we observe that the block-ML curve asymptotes at roughly 0.875 for low mean photon numbers per mode. This is because, in this regime, the BSC induced by the symbol-by-symbol measurement essentially has a bit-flip rate of 0.5. Therefore, block-ML computes a posterior that is almost uniform on all codewords, and thus the block success probability is 1/| [symbol] =⅛=0.125.
5. As another self-consistency check, we note that the BP curve asymptotes at roughly (1− 1/32)=0.9688 for low mean photon numbers per mode. Since BP performs bit-MAP on this FG, and the induced BSC in this regime flips bits at a rate of almost 0.5, BP essentially picks each bit uniformly at random, thereby returning a vector that is uniformly at random out of all the possible 2⁵=32 vectors of length 5.
6. The bit error probability plots show that even though BPQM is optimal for bits x₂ through x₅, it still performs slightly poorly when compared to the performance for x₁. This might be attributed to the fact that in the chosen parity-check matrix, bit x₁ is involved in both checks whereas the other bits are involved in exactly one of the two checks.

CQ polar codes are known to achieve capacity on CQ channels when paired with a quantum successive cancellation decoder. It remains to be seen if the same is also true for a BPQM-based decoder. The quantum optimality of BPQM shown in this paper for the example 5-bit code bodes well for BPQM in this regard. It also remains open as to how BPQM can be generalized to FGs with cycles and also for decoding over general CQ channels. BPQM also has close connections with the recently introduced notion of channel duality. The resulting entropic relations could help characterize the performance of a code over a channel using the performance of its dual code over the dual channel. Since the dual of the pure-state channel is the classical BSC, we believe it may be possible to extend classical techniques for analyzing BP (on BSC), such as density evolution, to analyze BPQM as well.

Leveraging optical realizations of “cat basis” quantum logic, i.e., single- and two-qubit quantum gates in the span of coherent states |β [symbol] and |−β [symbol] , our BPQM quantum circuit can be translated into the first fully-structured optical receiver that would attain the quantum limit of minimum-error discrimination of more than two coherent states.

Since there is a proven classical-quantum performance gap as discussed above, implementing our receiver on an optical quantum processor provides an alternative proposal for a quantum supremacy experiment that is distinct from the conventional proposals based on random circuits.

We will now analyze the BPQM algorithm on the example 5-bit code shown in FIG. 2. Let us begin by describing the procedure to decode bit 1 of the 5-bit code from FIG. 2. Observe that the codewords belonging to the code are

[symbol]

={00000, 00011, 01100, 01111, 10101, 10110, 11001, 11010}. (3)

We assume that all the codewords are equally likely to be transmitted, just as in classical BP. Then the task of decoding the value of the first bit x₁ involves distinguishing between the density matrices ρ₁⁽⁰⁾ and ρ₁⁽¹⁾, which are uniform mixtures of the states corresponding to the codewords that have x₁=0 and x₁=1, respectively, i.e.,

$$\begin{matrix}{{{{{{{{{{ρ}_{1}^{( 0 )} = \vert θ 〉 〈 θ \vert}_{1} ⊗ \frac{1}{4} [ \vert θ 〉 〈 θ \vert}_{2} ⊗ \vert θ 〉 〈 θ \vert}_{3} ⊗ \vert θ 〉 〈 θ \vert}_{4} ⊗ \vert θ 〉 〈 θ \vert}_{5} + \vert θ 〉 〈 θ \vert}_{2} ⊗ \vert θ 〉 〈 θ \vert}_{3} ⊗ \vert - θ 〉 〈 - θ \vert}_{4} ⊗ \vert - θ 〉 〈 - θ \vert}_{5} & ( 4 ) \\ {{{{+ \vert - θ 〉 〈 - θ \vert}_{2} ⊗ \vert - θ 〉 〈 - θ \vert}_{3} ⊗ \vert θ 〉 〈 θ \vert}_{4} ⊗ \vert θ 〉 〈 θ \vert}_{5} & ( 5 ) \\ {{{{+ \vert - θ 〉 〈 - θ \vert}_{2} ⊗ \vert - θ 〉 〈 - θ \vert}_{3} ⊗ \vert - θ 〉 〈 - θ \vert}_{4} ⊗ \vert - θ 〉 〈 - θ \vert}_{5} ] , & ( 6 ) \\ {{{{{{{{{{ρ}_{1}^{( 1 )} = \vert - θ 〉 〈 - θ \vert}_{1} ⊗ \frac{1}{4} [ \vert θ 〉 〈 θ \vert}_{2} ⊗ \vert - θ 〉 〈 - θ \vert}_{3} ⊗ \vert θ 〉 〈 θ \vert}_{4} ⊗ \vert - θ 〉 〈 - θ \vert}_{5} + \vert θ 〉 〈 θ \vert}_{2} ⊗ \vert - θ 〉 〈 - θ \vert}_{3} ⊗ \vert - θ 〉 〈 - θ \vert}_{4} ⊗ \vert θ 〉 〈 θ \vert}_{5} & ( 7 ) \\ {{{{+ \vert - θ 〉 〈 - θ \vert}_{2} ⊗ \vert θ 〉 〈 θ \vert}_{3} ⊗ \vert θ 〉 〈 θ \vert}_{4} ⊗ \vert - θ 〉 〈 - θ \vert}_{5} & ( 8 ) \\ {{{{+ \vert - θ 〉 〈 - θ \vert}_{2} ⊗ \vert θ 〉 〈 θ \vert}_{3} ⊗ \vert - θ 〉 〈 - θ \vert}_{4} ⊗ \vert θ 〉 〈 θ \vert}_{5} ] . & ( 9 )\end{matrix}$$

These density matrices can be written in terms of the factor node (FN) channel convolution, explained below, as ρ₁^{x}^{₁}=ρ_{±}=|±θ [symbol] [symbol] ±θ|₁⊗[W [symbol] W](x₁)₂₃⊗[W [symbol] W](x₁)₄₅, where we use the notation ±≡(−1)^{x}^{₁}, x₁∈{0, 1}

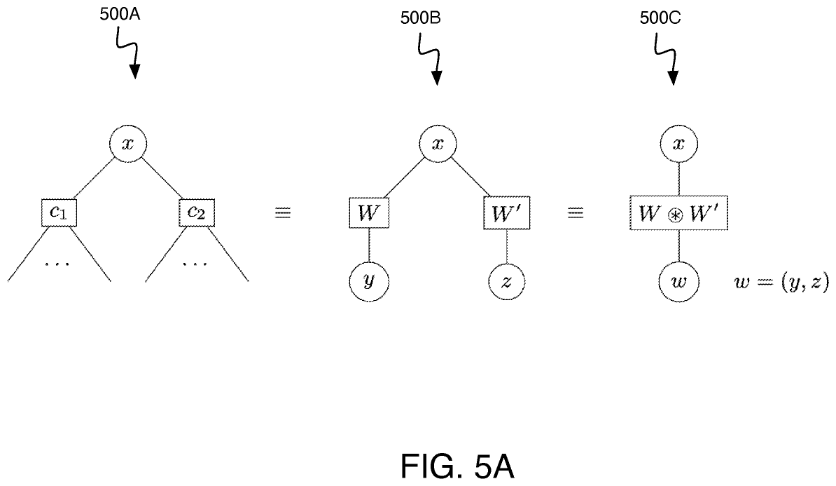

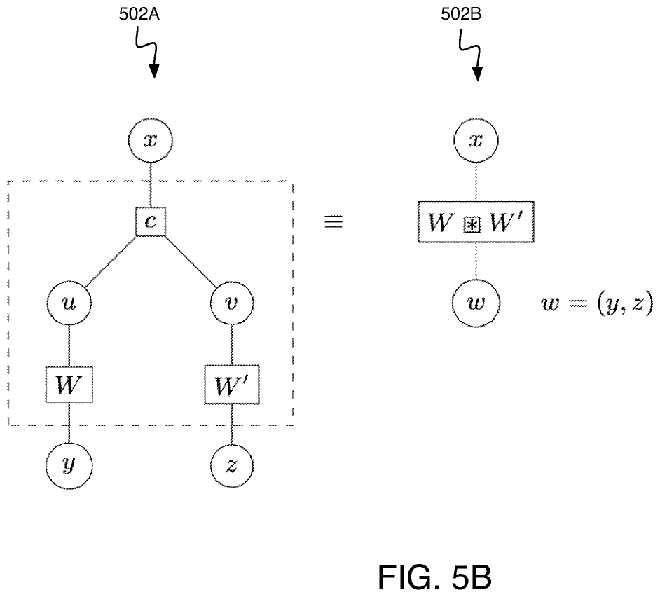

It is very convenient to represent the operations performed by BP at each factor node (FN) and variable node (VN) abstractly as “local inference” over a “locally induced channel”. For convenience, we consider a VN that is attached to exactly two FNs since a degree-d VN can always be analyzed by sequentially merging two attached edges at a time. FIG. 5A illustrates this process for a VN. In FIG. 5A, all VNs other than x that are connected to c₁ and c₂ can be combined into the VNs y and z, respectively. The VNs y and z represent independent observations of the variable x through the induced channels W and W′, respectively.

Note that this independence occurs precisely when the full FG is a tree. The channel W (respectively W′) represents the conditional probability of all VNs in the subtree rooted at c₁ (respectively c₂) given x. The two induced channels can be combined into a single channel W [symbol] W′ whose outputs are the concatenation of y and z. The transition probabilities of this channel are

[W [symbol] W′](y,z|x)=W(y|x)·W′(z|x,y) (10)

=W(y|x)·W′(z|x). (11)

This is called the variable node convolution of two channels. Hence, the VN update operation of BP is simply performing local inference over the local channel W [symbol] W′ i.e., calculating the local posterior for x given (y,z).

Similarly, at a (degree-3) FN we have a single input x “splitting” into two outputs u and v (since they sum to x), whose independent observations through the underlying physical channel, as well as the remaining part of the FG, are obtained as y and z. Then we have only two possibilities, either u=x and v=0 or u=x⊕1 and v=1, and both of them are equally likely. Note that this is due to linearity of the code and holds under the assumption that the code does not have a trivial bit position where all codewords take the value 0. Hence, the FN convolution of two channels W and W′ is given by

[W [symbol] W′](y,z|x)=½W(y|u=x)·W′(z|v=0)+½W(y|u=x⊕1)·W′(z|v=1) (12)

=½W(y|x)·W′(z|0)+½W(y|x⊕1)·W′(z|1). (13)

We can perform a quick calculation using the FN update operation of BP to verify that BP is indeed performing local inference on this locally induced channel. In FIG. 2, consider the BP update at the FN c₁. We observe that

$${\sum }_{{x}_{2} , {x}_{3} ∈ {\{ 0 , 1 \}}^{2}} ( {x}_{1} ⊕ {x}_{2} ⊕ {x}_{3} = 0 ) W ( {y}_{2} \vert {x}_{2} ) W ( {y}_{3} \vert {x}_{3} ) = {\sum }_{{x}_{2} , {x}_{3} ∈ {\{ 0 , 1 \}}^{2}} ( {x}_{2} ⊕ {x}_{3} = {x}_{1} ) W ( {y}_{2} \vert {x}_{2} ) W ( {y}_{3} \vert {x}_{3} ) \qquad ( 14 )$$

$$= W ( {y}_{2} \vert {x}_{2} = {x}_{1} ) \cdot W ( {y}_{3} \vert {x}_{3} = 0 ) + W ( {y}_{2} \vert {x}_{2} = {x}_{1} ⊕ 1 ) \cdot W ( {y}_{3} \vert {x}_{3} = 1 ) \qquad ( 15 )$$

$$∝ [ W W ] ( {y}_{2} , {y}_{3} \vert {x}_{1} ) , \qquad ( 16 )$$

where we need the factor ½ to make sure that it is an exact marginal (which we had omitted at the beginning of BP, in the MAP formulation, for convenience), or equivalently to ensure that W [symbol] W′ is indeed a channel.
This perspective on BP extends to quantum observations and aids one in defining the channel combining operations for a classical-quantum (CQ) channel W(x)≡W(|x [symbol] [symbol] x|), x∈{0, 1}, as follows:

[W [symbol] W′](x):=W(x)⊗W′(x), (17)

[W [symbol] W′](x):=½W(x)⊗W′(0)+½W(x⊕1)⊗W′(1). (18)

Here, we use notation which suppresses the outputs “(y,z)” that were present in the classical channel convolutions (11) and (13). This is because we do not observe the output in the quantum case unless we measure it, and measuring each channel output is not always the optimal operation at the receiver.

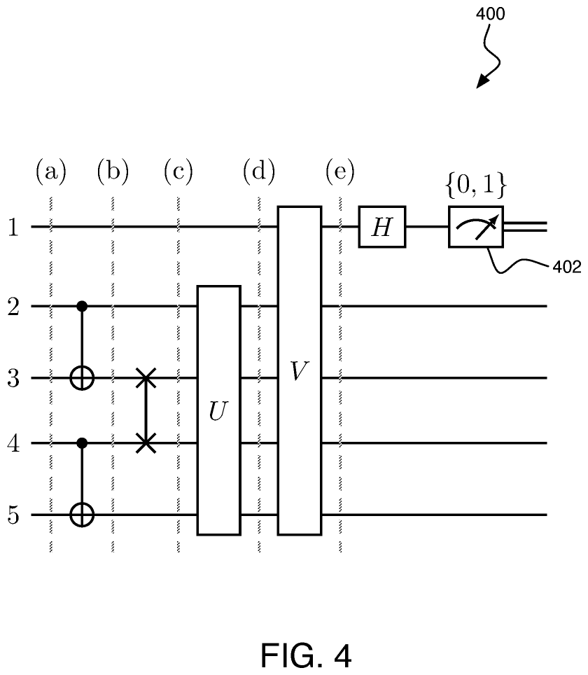

The BPQM circuit for decoding x₁ is shown in FIG. 4 along with the density matrix in each stage of the circuit denoted by (a) through (e).

ρ_{±,a}=|±θ [symbol] [symbol] ±θ|₁⊗[W [symbol] W](x₁)₂₃⊗[W [symbol] W](x₁)₄₅. (1)

ρ_{±,b}=|±θ [symbol] [symbol] ±θ|₁⊗Σ_{j∈{0,1}}pⱼ|±θ« [symbol] ±θ [symbol] |₂⊗|j [symbol] [symbol] j|₃⊗Σ_{k∈{0,1}}pₖ|± [symbol] [symbol] ± [symbol] ± [symbol] |₄⊗|k [symbol] [symbol] k|₅. (b)

ρ_{±,c}=|±θ [symbol] [symbol] ±θ|₁⊗Σ_{j,k∈{0,1}}_{²}pⱼpₖ|±θ [symbol] [symbol] ± [symbol] |₂⊗|± [symbol] [symbol] ± [symbol] |₃⊗|j [symbol] [symbol] j|₄⊗|k [symbol] [symbol] k|₅. (c)

σ_{±}=Σ_{j,k∈{0,1}}_{²}pⱼpₖ|±θχ [symbol] ±θ|₁⊗|± [symbol] [symbol] ±θ [symbol] ₂⊗|0 [symbol] [symbol] 0|₃⊗|jk [symbol] [symbol] jk|₄₅, (d)

where the applied unitary operation is U:=Σ_{j,k∈{0,1}}_{²} [symbol] )₂₃⊗|jkχ [symbol] jk|₄₅ and cos [symbol] :=cos [symbol] cos [symbol] .

Ψ_{±}=Σ_{j,k∈{0,1}}_{²}pⱼpₖ|± [symbol] [symbol] ± [symbol] |₁⊗|0χ [symbol] 0|₂⊗|0χ [symbol] 0|₃⊗|jkχ [symbol] jk|₄₅, (e)

where the applied unitary operation is V:=Σ_{j,k∈{0,1}}_{²} [symbol] (θ [symbol] )₁₂⊗|jkχ [symbol] jk|₄₅ and cos [symbol] :=cosθcos [symbol] .

We emphasize that at each stage, the density matrix is the expectation over all pure states obtained there that correspond to transmitted codewords with the first bit taking value x₁∈{0, 1}. The operations U and V are effectively two-qubit unitary operations, albeit controlled ones, and this phenomenon extends to any factor graph. Evidently, BPQM compresses all the quantum information into system 1 and the problem reduces to distinguishing between Ψ_{±}⁽¹⁾=σ_{j,k∈{0,1}}_{²}pⱼpₖ|± [symbol] [symbol] ± [symbol] |₁, since the other systems are either trivial or completely classical and independent of x₁. Finally, system 1 is measured by projecting onto the Pauli X basis, which we know to be the Helstrom measurement to optimally distinguish between the states) Ψ_{±}⁽¹⁾.

It is pertinent that the optimal success probability of distinguishing between the density matrices ρ₁^{(0) and ρ}₁⁽¹⁾ using a collective Helstrom measurement is given by

p_{succ,1}^{Hel}½+¼∥ρ₁⁽⁰⁾−ρ₁⁽¹⁾∥₁, ∥M∥₁:=Tr(\sqrt{M^{†}M}). (19)

The action of BPQM until the final measurement is unitary and the trace norm ∥⋅∥₁ is invariant under unitaries. Thus, BPQM does not lose optimality until the final measurement. Since the final measurement is also optimal for distinguishing the two possible states at that stage (e), BPQM is indeed optimal in decoding the value of x₁. Thus, despite not performing a collective measurement, but rather only a single-qubit measurement at the end of a sequence of unitaries motivated by the FG structure and induced channels in classical BP, BPQM is still optimal to determine whether x₁=0 or 1.

We now analyze the performance of the receiver in decoding bit 1. The probability to decode it as \hat{x}₁=0 is

$$ℙ [ {\hat{x}}_{1} = 0 \vert {Ψ}_{\pm }^{( 1 )} ] = Tr [ {Ψ}_{\pm }^{( 1 )} \vert + 〉 〈 + \vert ] = {\sum }_{j , k ∈ {\{ 0 , 1 \}}^{2}} {p}_{j} {p}_{k} ( \frac{1 \pm sin}{2} ) . \qquad ( 20 )$$

Therefore, since there are 4 codewords each that have x₁=0 and x₁=1, the prior for bit x₁ is ½ and the probability of success for BPQM in decoding the bit x₁ is

$${P}_{succ , 1}^{BPQM} = ℙ [ {x}_{1} = 0 ] \cdot ℙ [ {\hat{x}}_{1} = 0 \vert {x}_{1} = 0 ] + ℙ [ {x}_{1} = 1 ] \cdot ℙ [ {\hat{x}}_{1} = 1 \vert {x}_{1} = 1 ] \qquad ( 21 )$$

$$\begin{matrix}= \frac{1}{2} [ {\sum }_{j , k ∈ {\{ 0 , 1 \}}^{2}} {p}_{j} {p}_{k} ( \frac{1 + sin}{2} ) + {\sum }_{j , k ∈ {\{ 0 , 1 \}}^{2}} {p}_{j} {p}_{k} ( \frac{1 + sin}{2} ) ] & ( 22 ) \\ = \frac{{p}_{0}^{2}}{2} ( 1 + sin ) + ( 1 - {p}_{0}^{2} ) & ( 23 ) \\ = 1 - \frac{{p}_{0}^{2}}{2} ( 1 - sin ) , & ( 24 )\end{matrix}$$

where we have used the fact that since all channels are identically W, we have cos [symbol] =0. We can calculate

$$cos = cos θ cos = cos θ {cos}^{2} = cos θ \frac{4 {cos}^{2} θ}{{( 1 + {cos}^{2} θ )}^{2}} \qquad ( 25 )$$

$$⇒ sin = \sqrt{1 - \frac{16 {cos}^{6} θ}{{( 1 + {cos}^{2} θ )}^{4}}} = \sqrt{1 - \frac{{( 2 {p}_{0} - 1 )}^{3}}{{p}_{0}^{4}}} = \frac{\sqrt{{p}_{0}^{4} - {( 2 {p}_{0} - 1 )}^{3}}}{{p}_{0}^{2}} . \qquad ( 26 )$$

Substituting back, we get the BPQM probability of success for bit x₁ to be

$${P}_{succ , 1}^{BPQM} = 1 - \frac{{p}_{0}^{2} - \sqrt{{p}_{0}^{4} - {( 2 {p}_{0} - 1 )}^{3}}}{2} = {P}_{succ , 1}^{1 Hel} . \qquad ( 27 )$$

Before measuring system 1, the state of system 1 is essentially Ψ_{±}⁽¹⁾=ρ₀²|± [symbol] [symbol] ± [symbol] |+(1−p₀²)|± [symbol] [symbol] ±|, since cos [symbol] =0 whenever either j or k equals 1 (or both) and hence |± [symbol] [symbol] ± [symbol] |=|± [symbol] [symbol] ±|. So, p₀² is the probability that the system “confuses” the decoder, and projection onto the X basis essentially replaces the system with |m₁ [symbol] [symbol] m₁|, where m₁=(−1)^{\hat{x}}^{₁}∈{+,−}. The full post-measurement state is given by quantum mechanics to be

$${{{{Φ}_{{m}_{1}} = {\sum }_{j , k ∈ {\{ 0 , 1 \}}^{2}} {p}_{j} {p}_{k} \frac{{\vert 〈 {m}_{1} \vert \pm 〉 \vert}^{2}}{Tr [ {Ψ}_{\pm }^{( 1 )} \vert {m}_{1} 〉 〈 {m}_{1} \vert ]} \vert {m}_{1} 〉 〈 {m}_{1} \vert}_{1} ⊗ \vert 00 〉 〈 00 \vert}_{23} ⊗ \vert jk 〉 〈 jk \vert}_{45} . \qquad ( 28 )$$

Note that in FIG. 4, we need to apply a Hadamard after the Z-basis measurement in order to ensure that the effective projector is H|\hat{x}₁ [symbol] [symbol] \hat{x}₁|H=|m₁ [symbol] [symbol] m₁|.

Let us denote the overall unitary operation performed in FIG. 4 until stage (e) as B₁^{BPQM}. As mentioned earlier, the Helstrom measurement to optimally distinguish between ρ₁⁽⁰⁾ and ρ₁⁽¹⁾ is given by the POVM where {Π₁^{Hel}, [symbol] −Π₁^{Hel}}, where

$${\prod }_{1}^{Hel} := {\sum }_{i : {λ}_{i} \geq 0} \vert i 〉 〈 i \vert , ( {ρ}_{1}^{( 0 )} - {ρ}_{1}^{( 1 )} ) \vert i 〉 = {λ}_{i} \vert i 〉 . \qquad ( 29 )$$

BPQM performs the final Helstrom measurement given by the POVM {\tilde{Π}₁^{Hel}, [symbol] −\tilde{Π}₁^{Hel}}, where

$${{\tilde{\prod }}_{1}^{Hel} := {\sum }_{j : {λ}_{j} \geq 0} \vert j 〉 〈 j \vert = \vert + 〉 〈 + \vert}_{1} ⊗ {( {I}_{16} )}_{2345} , ( {Ψ}_{+} - {Ψ}_{-} ) \vert j 〉 = {λ}_{j} \vert j 〉 \qquad ( 30 )$$

$$\begin{matrix}⇒ [ {B}_{1}^{BPQM} {{ρ}_{1}^{( 0 )} ( {B}_{1}^{BPQM} )}^{†} - {B}_{1}^{BPQM} {{ρ}_{1}^{( 1 )} ( {B}_{1}^{BPQM} )}^{†} ] \vert j 〉 = {λ}_{j} \vert j 〉 & ( 31 ) \\ ⇒ ( {ρ}_{1}^{( 0 )} - {ρ}_{1}^{( 1 )} ) {( {B}_{1}^{BPQM} )}^{†} \vert j 〉 = {{λ}_{j} ( {B}_{1}^{BPQM} )}^{†} \vert j 〉 . & ( 32 )\end{matrix}$$

Thus, we can express the eigenvectors for (ρ₁⁽⁰⁾−ρ₁⁽¹⁾) as |i [symbol] =(B₁^{BPQM})^{†}|j [symbol] . This further implies that

$$\begin{matrix}{\prod }_{1}^{Hel} = {\sum }_{i : {λ}_{i} \geq 0} \vert i 〉 〈 i \vert = {( {B}_{1}^{BPQM} )}^{†} [ {\sum }_{j : {λ}_{j} \geq 0} \vert j 〉 〈 j \vert ] {B}_{1}^{BPQM} & ( 33 ) \\ {= {( {B}_{1}^{BPQM} )}^{†} [ \vert + 〉 〈 + \vert}_{1} ⊗ {( {I}_{16} )}_{2345} ] {B}_{1}^{BPQM} . & ( 34 )\end{matrix}$$

Hence, in order to identically apply the Helstrom measurement Π₁^{Hel}, BPQM needs to first apply B₁^{BPQM}, then measure the first qubit in the X-basis, and finally invert B₁^{BPQM} on the post-measurement state Φₘ_{₁} above. Although this is optimal for bit 1, next we will see that it is beneficial to coherently rotate Φₘ_{₁} before inverting B₁^{BPQM}, which sets up a better state discrimination problem for decoding bit 2.

In order to execute BPQM to decode bit x₂, we would ideally hope to change the state Φₘ_{₁} back to the channel outputs. However, this is impossible after having performed the measurement. In the basic BPQM algorithm, the procedure to be performed at this stage is ambiguous, so we describe a strategy that treads closely along the path of performing the Helstrom measurement for bit 2 as well, i.e., optimally distinguishing ρ₂⁽⁰⁾ and ρ₂⁽¹⁾ evolved through Ã₁^{BPQM}:=(B₁^{BPQM})^{†}[|m₁ [symbol] [symbol] m₁|₁⊗(I₁₆)₂₃₄₅]B₁^{BPQM}.

In order to be able to run BPQM for bit x₁ in reverse to get “as close” to the channel outputs as possible, we need to make sure that the state Φₘ_{₁} is modified to be compatible with the (angles used to define the) unitaries V and U in FIG. 4. Since we can keep track of the intermediate angles deterministically, we can conditionally rotate subsystem 1 to be |m₁ [symbol] [symbol] m₁ [symbol] |₁ for |jk [symbol] [symbol] ₄₅=|00 [symbol] [symbol] 00|₄₅. Note again that in Ψ_{±}, when either of j or k is 1 (or both), [symbol] =π/2 and hence |± [symbol] [symbol] ± [symbol] |=|±) [symbol] [symbol] ±|. Therefore, if \hat{x}₁ is the wrong estimate for x₁, then [symbol] m₁|± [symbol] =0 and the superposition in Φₘ_{₁} collapses to a single term with j=k=0.

More precisely, we can implement the unitary operation

Mₘ_{₁}:=(Kₘ_{₁})₁⊗|00 [symbol] [symbol] 00|₄₅+(I₂)₁⊗(|01 [symbol] [symbol] 01|₄₅+|10 [symbol] [symbol] 10|₄₅+|11 [symbol] [symbol] 11|₄₅), (35)

where K₊ and K₋ are unitaries chosen to satisfy K₊|+ [symbol] =| [symbol] [symbol] and K₋|− [symbol] =|− [symbol] [symbol] , respectively. We can easily complete these partially defined unitaries with the conditions

$${K}_{+} \vert - 〉 = sin \frac{2}{} \vert 0 〉 - cos \frac{2}{} \vert 1 〉$$

$$and {K}_{-} \vert + 〉 = sin \frac{2}{} \vert 0 〉 + cos \frac{2}{} \vert 1 〉 .$$

We will now explain the above notation, as well as decompose the unitary operators Kₘ_{₁} and [symbol] (θ, θ′). For the pure-state channel, the following operations are performed at variable nodes (VN) and factor nodes (FN). At a VN, the convolution W [symbol] W′ initially yields a CQ channel that only outputs either |θ [symbol] ⊗|θ′ [symbol] or |−θ [symbol] ⊗|−θ′ [symbol] . Note that the local convolution is performed with respect to input x=0 and x=1 separately, respectively inducing signs +and −. We say “initially” because we expect the signs of all incoming qubits at a VN to be the same, which means all independent local beliefs of the VN agree on the bit's value. Since the pure-state channel does not introduce noise, and the only uncertainty arises from the non-orthogonality of |θ [symbol] and |−θ [symbol] , the qubits always combine in this ideal fashion until the first bit is decoded. But, whether this situation continues beyond the first bit depends upon whether the first bit was decoded to be a 0 or 1. This is because, as mentioned earlier, the FN channel convolution in (18) is defined assuming that the FN imposes an even parity-check. If, instead, it imposed an odd parity-check, as will happen when one of the bits is decoded to be a 1, then the FN convolution has to be modified appropriately. Therefore, if the FN originally had degree 3 and one of the bits was estimated to be 1, then we can remove the bit and update the FN to be an odd parity-check on two bits. This degree-2 FN effectively induces a modified VN convolution with the signs of the two qubits in disagreement.

Given the (ideal) convolution outputs, the following unitary is applied to “compress” the information into one qubit and force the other system to be in state |0 [symbol] :

$$( θ , {θ}^{′} ) := [ \begin{matrix}{a}_{+} & 0 & 0 & {a}_{-} \\ {a}_{-} & 0 & 0 & - {a}_{+} \\ 0 & {b}_{+} & {b}_{-} & 0 \\ 0 & {b}_{-} & - {b}_{+} & 0\end{matrix} ] , \qquad ( 36 )$$

$${a}_{\pm } := \frac{1}{\sqrt{2}} \frac{cos ( \frac{θ - {θ}^{′}}{2} ) \pm cos ( \frac{θ + {θ}^{′}}{2} )}{\sqrt{1 + cos θ cos {θ}^{′}}} , \\ {b}_{\pm } := \frac{sin ( \frac{θ + {θ}^{′}}{2} ) ∓ sin ( \frac{θ - {θ}^{′}}{2} )}{\sqrt{1 - cos θ cos {θ}^{′}}} . \qquad ( 37 )$$

Hence, we have [symbol] (θ, θ′)(|±θ [symbol] ⊗|±θ′ [symbol] )=|± [symbol] [symbol] ⊗|0 [symbol] , where cos [symbol] :=cosθcosθ′. The VN update just passes the qubit in the first system and ignores the second system.

At the FN, the induced mixed state [W [symbol] W′](x) can be transformed into the CQ state Σ_{j∈{0,1}}pⱼ|± [symbol] [symbol] ± [symbol] |⊗|j [symbol] [symbol] j| by performing [symbol] :=CNOT_{W→W′}, the controlled-NOT gate with W as control and W′ as target. Hence,

$$( [ W {W}^{′} ] ( x ) ) = {\sum }_{j ∈ \{ 0 , 1 \}} {p}_{j} \vert \pm 〉 〈 \pm \vert ⊗ \vert j 〉 〈 j \vert , \qquad ( 38 )$$

$${p}_{0} := \frac{1}{2} ( 1 + cos θ cos {θ}^{′} ) , {p}_{1} := 1 - ; {p}_{0} , \\ cos := \frac{cos θ + cos {θ}^{′}}{1 + cos θ cos {θ}^{′}} , cos := \frac{cos θ - cos {θ}^{′}}{1 - cos θ cos {θ}^{′}} . \qquad ( 39 )$$

Observe that for j=0, the angle between the states has decreased, while for j=1 the angle has increased. The FN update is then to measure the second system and pass the resulting qubit in the first system as the message, along with the result of the classical measurement (or the resulting value of [symbol] ). This is because the VN update at the next stage needs to know the angles θ, θ′ of the incoming qubits. When we have a degree d node, these channel convolutions can be performed two at a time.

Let CNOT_{θ′→θ}=I₂⊗|0 [symbol] [symbol] 0|+X⊗|1 [symbol] [symbol] 1| be the controlled-NOT operation with the (second) qubit corresponding to angle θ′ as the control qubit. Then we observe that

$$( θ , {θ}^{′} ) := ( θ , {θ}^{′} ) {CNOT}_{{θ}^{′} \to θ} = [ \begin{matrix}{a}_{+} & {a}_{-} & 0 & 0 \\ {a}_{-} & - {a}_{+} & 0 & 0 \\ 0 & 0 & {b}_{-} & {b}_{+} \\ 0 & 0 & - {b}_{+} & {b}_{-}\end{matrix} ] , \qquad ( 40 )$$

$$\begin{matrix}= \vert 0 〉 〈 0 \vert ⊗ [ \begin{matrix}{a}_{+} & {a}_{-} \\ {a}_{-} & - {a}_{+}\end{matrix} ] + \vert 1 〉 〈 1 \vert ⊗ [ \begin{matrix}{b}_{-} & {b}_{+} \\ - {b}_{+} & {b}_{-}\end{matrix} ] & ( 41 ) \\ = : \vert 0 〉 〈 0 \vert ⊗ {U}_{1} + \vert 1 〉 〈 1 \vert ⊗ {U}_{2} & ( 42 ) \\ = ( \vert 0 〉 〈 0 \vert ⊗ {U}_{1} + \vert 1 〉 〈 1 \vert ⊗ {I}_{2} ) ( \vert 0 〉 〈 0 \vert ⊗ {I}_{2} + \vert 1 〉 〈 1 \vert ⊗ {U}_{2} ) . & ( 43 )\end{matrix}$$

Let Rₚ(θ):=exp(−lθ/2p) denote Pauli rotations, where p∈{x,y,z} and l:=\sqrt{−1}. Then the Z-Y decomposition for a single qubit implies that any unitary U can be decomposed as

$$U = {e}^{ια} {R}_{z} ( β ) {R}_{y} ( γ ) {R}_{z} ( δ ) = [ \begin{matrix}{e}^{ι ( α - β / 2 - δ / 2 )} cos \frac{γ}{2} & - {e}^{ι ( α - β / 2 + δ / 2 )} sin \frac{γ}{2} \\ {e}^{ι ( α + β / 2 - δ / 2 )} sin \frac{γ}{2} & {e}^{ι ( α + β / 2 + δ / 2 )} cos \frac{γ}{2}\end{matrix} ] . \qquad ( 44 )$$

Setting γ₁:=2 sin⁻¹ (a₋) and β₂:=2 sin⁻¹ (b₊), we observe that

$${U}_{1} = [ \begin{matrix}cos \frac{{γ}_{1}}{2} & sin \frac{{γ}_{1}}{2} \\ sin \frac{{γ}_{1}}{2} & - cos \frac{{γ}_{1}}{2}\end{matrix} ] = {e}^{\frac{ιπ}{2}} {R}_{y} ( {γ}_{1} ) {R}_{z} ( π ) = : {e}^{\frac{ιπ}{2}} {A}_{1} {XB}_{1} {XC}_{1} , \qquad ( 45 )$$

$${A}_{1} := {R}_{y} ( \frac{{γ}_{1}}{2} ) , \qquad ( 46 )$$

$${B}_{1} := {R}_{y} ( \frac{- {γ}_{1}}{2} ) {R}_{z} ( \frac{- π}{2} ) , \qquad ( 47 )$$

$${C}_{1} := {R}_{z} ( \frac{π}{2} ) , \qquad ( 48 )$$

$${U}_{2} = [ \begin{matrix}cos \frac{{γ}_{2}}{2} & sin \frac{{γ}_{2}}{2} \\ - sin \frac{{γ}_{2}}{2} & cos \frac{{γ}_{2}}{2}\end{matrix} ] = {e}^{ιπ} {R}_{z} ( π ) {R}_{y} ( {γ}_{2} ) {R}_{z} ( π ) = : {e}^{ιπ} {A}_{2} {XB}_{2} X , \qquad ( 49 )$$

$${A}_{2} := {R}_{z} ( π ) {R}_{y} ( {γ}_{2} / 2 ) , \qquad ( 50 )$$

$${B}_{2} := {R}_{y} ( - {γ}_{2} / 2 ) {R}_{z} ( - π ) . \qquad ( 51 )$$

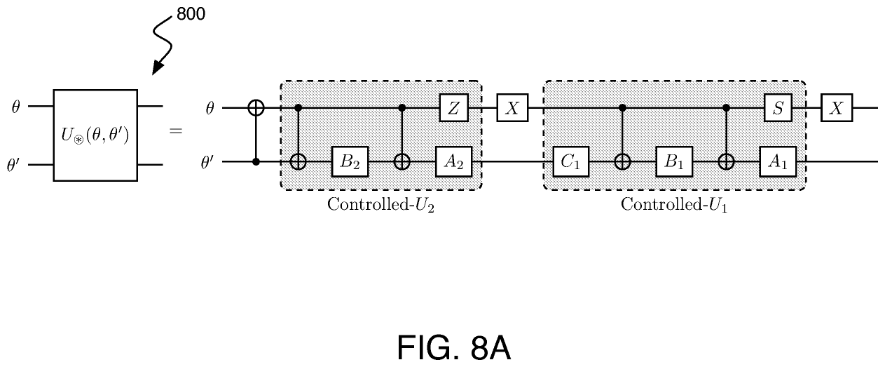

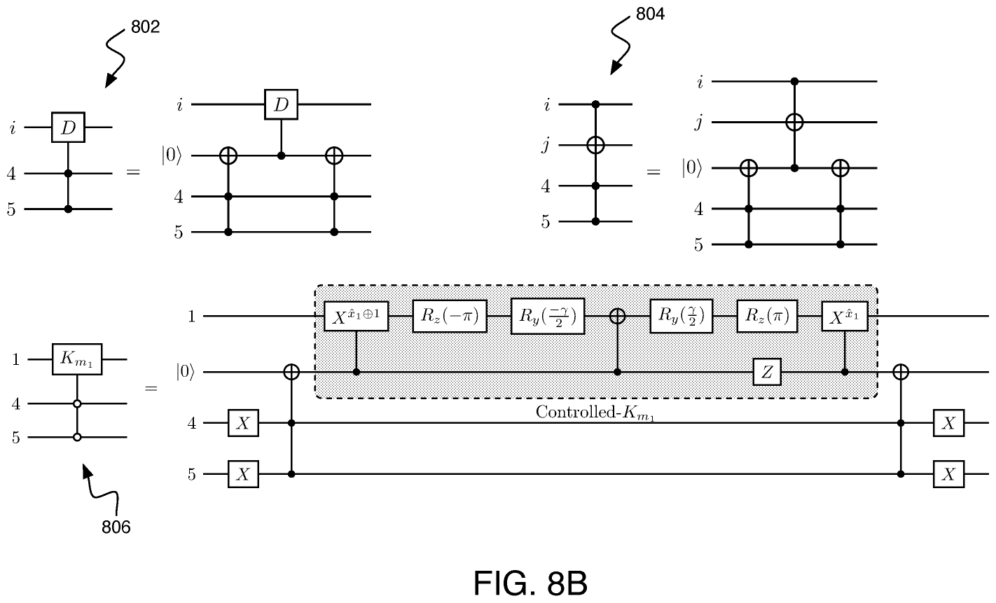

Then we can express the full circuit decomposition for [symbol] (θ, θ′) as shown in FIG. 8A.
Similarly, the rotations K₊ and K₋ defined in (35) can be expressed as

$$\begin{matrix}{K}_{+} = \frac{1}{\sqrt{2}} [ \begin{matrix}cos \frac{2}{} + sin \frac{2}{} & cos \frac{2}{} - sin \frac{2}{} \\ sin \frac{2}{} - cos \frac{2}{} & sin \frac{2}{} + cos \frac{2}{}\end{matrix} ] & ( 52 ) \\ = : [ \begin{matrix}cos \frac{γ}{2} & sin \frac{γ}{2} \\ - sin \frac{γ}{2} & cos \frac{γ}{2}\end{matrix} ] & ( 53 ) \\ = {e}^{ιπ} {R}_{z} ( π ) {R}_{y} ( γ ) {R}_{z} ( π ) & ( 54 ) \\ = : {e}^{ιπ} {A}_{+} {XB}_{+} X , & ( 55 ) \\ {K}_{-} = \frac{1}{\sqrt{2}} [ \begin{matrix}sin \frac{2}{} + cos \frac{2}{} & sin \frac{2}{} - cos \frac{2}{} \\ cos \frac{2}{} - sin \frac{2}{} & cos \frac{2}{} + sin \frac{2}{}\end{matrix} ] & ( 56 ) \\ = {K}_{+}^{†} , & ( 57 ) \\ where γ := 2 {sin}^{- 1} [ \frac{1}{\sqrt{2}} ( cos \frac{2}{} - sin \frac{2}{} ) ] , & ( 58 ) \\ {A}_{+} := {R}_{z} ( π ) {R}_{y} ( \frac{γ}{2} ) , & ( 59 ) \\ {B}_{+} := {R}_{y} ( \frac{- γ}{2} ) {R}_{z} ( - π ) . & ( 60 )\end{matrix}$$

The coherently controlled gate Mₘ_{₁} defined above is decomposed in FIG. 8B using the above calculations.

Applying Mₘ_{₁} to Φₘ_{₁} we get the desired state (compare to state Ψ_{±} in stage (e) of FIG.

$${{{{\tilde{Ψ}}_{{m}_{1}} = {\sum }_{j , k ∈ {\{ 0 , 1 \}}^{2}} {p}_{j} {p}_{k} \frac{{\vert 〈 {m}_{1} \vert \pm 〉 \vert}^{2}}{Tr [ {Ψ}_{\pm }^{( 1 )} \vert {m}_{1} 〉 〈 {m}_{1} \vert ]} \vert {m}_{1} 〉 〈 {m}_{1} \vert}_{1} ⊗ \vert 00 〉 〈 00 \vert}_{23} ⊗ \vert jk 〉 〈 jk \vert}_{45} . \qquad ( 61 )$$

Now the BPQM circuit for bit x₁, shown in FIG. 4, can be run in reverse from before the final measurement, i.e., from stage (e) back to stage (a). Hence, the overall operation on the input state in FIG. 4 is

A₁^{BPQM}:=(B₁^{BPQM})^{†}Mₘ_{₁}[|m₁ [symbol] m₁|₁⊗(I₁₆)₂₃₄₅]B₁^{BPQM}. (62)

Then we expect the state to be almost the same as the channel outputs, except that system 1 will deterministically be in state |m₁θ [symbol] m₁θ|₁. However, a simple calculation shows that this is not completely true since the additional factor

$$\frac{{\vert 〈 {m}_{1} \vert \pm 〉 \vert}^{2}}{Tr [ {Ψ}_{\pm }^{( 1 )} \vert {m}_{1} 〉 〈 {m}_{1} \vert ]}$$

prevents the density matrix to decompose into a tensor product of two 2-qubit density matrices at stage (b) of FIG. 4.

Specifically, when we take \tilde{Ψ}ₘ_{₁} at stage (e) back to stage (b) by inverting the BPQM operations, we arrive at the state

$$\begin{matrix}{{\tilde{ρ}}_{\pm , b}^{( {m}_{1} )} = \vert {m}_{1} θ 〉 〈 {m}_{1} θ \vert}_{1} & ( 63 )\end{matrix}$$

$$\begin{matrix}{{⊗ {\sum }_{j , k ∈ {\{ 0 , 1 \}}^{2}} {p}_{j} {p}_{k} \frac{{\vert 〈 {m}_{1} \vert \pm 〉 \vert}^{2}}{Tr [ {Ψ}_{\pm }^{( 1 )} \vert {m}_{1} 〉 〈 {m}_{1} \vert ]} ( \vert {m}_{1} 〉 〈 {m}_{1} \vert}_{2} ⊗ \vert j 〉 〈 j \vert}_{3} ) & ( 64 )\end{matrix}$$

$$\begin{matrix}{{⊗ ( \vert {m}_{1} 〉 〈 {m}_{1} \vert}_{4} ⊗ \vert k 〉 〈 k \vert}_{5} ) & ( 65 )\end{matrix}$$

$$= \{ \begin{matrix}{\frac{1}{{P}_{succ , 1}^{BPQM}} \vert {m}_{1} θ 〉 〈 {m}_{1} θ \vert}_{1} ⊗ {\sum }_{j , k ∈ {\{ 0 , 1 \}}^{2}} {p}_{j} {p}_{k} \vert 〈 {m}_{1} \vert \pm & if {\hat{x}}_{1} = {x}_{1} , \\ {{{{{〉 \vert}^{2} ( \vert {m}_{1} 〉 〈 {m}_{1} \vert}_{2} ⊗ \vert j 〉 〈 j \vert}_{3} ) ⊗ ( \vert {m}_{1} 〉 〈 {m}_{1} \vert}_{4} ⊗ \vert k 〉 〈 k \vert}_{5} ) & \\ {{{{{\vert {m}_{1} θ 〉 〈 {m}_{1} θ \vert}_{1} ⊗ ( \vert {m}_{1} 〉 〈 {m}_{1} \vert}_{2} ⊗ \vert 0 〉 〈 0 \vert}_{3} ) ⊗ ( \vert {m}_{1} 〉 〈 {m}_{1} \vert}_{4} ⊗ \vert 0 〉 〈 0 \vert}_{5} ) & if {\hat{x}}_{1} \neq {x}_{1} .\end{matrix} \qquad ( 66 )$$

$$Let C := {( {I}_{2} )}_{1} ⊗ {CNOT}_{2 \to 3} ⊗ {CNOT}_{4 \to 5} and \vert {Γ}_{{\hat{x}}_{1}} 〉 := cos \frac{2}{} \vert 00 〉 + {( - 1 )}^{{\hat{x}}_{1}} sin \frac{2}{} \vert 11 〉 . \qquad ( 67 )$$

$$Then$$

$$C {\tilde{ρ}}_{\pm , b}^{( {m}_{1} )} {C}^{†} = \{ \begin{matrix}{\frac{1}{{P}_{succ , 1}^{BPQM}} \vert {m}_{1} θ 〉 〈 {m}_{1} θ \vert}_{1} ⊗ [ W W ] {( {\hat{x}}_{1} )}_{23} ⊗ [ W W ] {( {\hat{x}}_{1} )}_{45} + \frac{{p}_{0}^{2}}{{P}_{succ , 1}^{BPQM}} [ 0.5 ( 1 + & if {\hat{x}}_{1} = {x}_{1} , \\ {{{sin ) - 1 ] \vert {m}_{1} θ 〉 〈 {m}_{1} θ \vert}_{1} ⊗ \vert {Γ}_{{\hat{x}}_{1}} 〉 〈 {Γ}_{{\hat{x}}_{1}} \vert}_{23} ⊗ \vert {Γ}_{{\hat{x}}_{1}} 〉 〈 {Γ}_{{\hat{x}}_{1}} \vert}_{45} & \\ {{{\vert {m}_{1} θ 〉 〈 {m}_{1} θ \vert}_{1} ⊗ \vert {Γ}_{{\hat{x}}_{1}} 〉 〈 {Γ}_{{\hat{x}}_{1}} \vert}_{23} ⊗ \vert {Γ}_{{\hat{x}}_{1}} 〉 〈 {Γ}_{{\hat{x}}_{1}} \vert}_{45} & if {\hat{x}}_{1} \neq {x}_{1} .\end{matrix}$$

We know from the definition of the factor node convolution operation of BPQM that

$$\begin{matrix}{C ( \vert {m}_{1} θ 〉 〈 {m}_{1} θ \vert}_{1} ⊗ [ W W ] {( {\hat{x}}_{1} )}_{23} ⊗ [ W W ] {( {\hat{x}}_{1} )}_{45} ) {C}^{†} = & ( 68 ) \\ {{{\vert {m}_{1} θ 〉 〈 {m}_{1} θ \vert}_{1} ⊗ ( {\sum }_{j ∈ \{ 0 , 1 \}} {p}_{j} \vert {m}_{1} 〉 〈 {m}_{1} \vert}_{2} ⊗ \vert j 〉 〈 j \vert}_{3} ) & \end{matrix}$$

$${{⊗ ( {\sum }_{k ∈ \{ 0 , 1 \}} {p}_{k} \vert {m}_{1} 〉 〈 {m}_{1} \vert}_{4} ⊗ \vert k 〉 〈 k \vert}_{5} ) \qquad ( 69 )$$

$$= {ρ}_{{m}_{1} , b} . \qquad ( 70 )$$

This in turn implies that [symbol] ρₘ_{₁}_{,b} [symbol] ^{†}=|m₁θ [symbol] m₁θ|₁⊗[W [symbol] W](\hat{X}₁)₂₃⊗[W [symbol] W](\hat{x}₁)₄₅.
Ignoring the first qubit and the constant factor for simplicity, observe that

$$\begin{matrix}{\tilde{ρ}}_{\pm , b}^{( {m}_{1} )} {\vert}_{{\hat{x}}_{1} = {x}_{1}} = {\sum }_{j , k ∈ {\{ 0 , 1 \}}^{2}} {p}_{j} {p}_{k} ( {\vert 〈 {m}_{1} \vert \pm 〉 \vert}^{2} - & ( 71 ) \\ {1 + 1 ) \vert {m}_{1} 〉 〈 {m}_{1} \vert}_{2} & \end{matrix}$$

$${{{⊗ \vert j 〉 〈 j \vert}_{3} ⊗ ( \vert {m}_{1} 〉 〈 {m}_{1} \vert}_{4} ⊗ \vert k 〉 〈 k \vert}_{5} ) \qquad ( 72 )$$

$${{= {ρ}_{{m}_{1} , b} + {p}_{0}^{2} [ 0.5 ( 1 + sin ) - 1 ] ( \vert {m}_{1} 〉 〈 {m}_{1} \vert}_{2} ⊗ \vert 0 〉 〈 0 \vert}_{3} ) \qquad ( 73 )$$

$${{⊗ ( \vert {m}_{1} 〉 〈 {m}_{1} \vert}_{4} ⊗ \vert 0 〉 〈 0 \vert}_{5} ) . \qquad ( 74 )$$

We have used the fact that except when j=k=0, assuming \hat{x}₁=x₁, [symbol] m₁|± [symbol] [symbol] = [symbol] m₁|m₁ [symbol] [symbol] = [symbol] m₁|m₁ [symbol] =1. Finally, using CNOT_{2→3}(|m₁ [symbol] ₂⊗|0 [symbol] ₃)=|Γ_{\hat{x}}_{₁} [symbol] , the result follows for both cases \hat{x}₁=x₁ and \hat{x}₁≠x₁.

Therefore, after reversing the operations of BPQM for bit x₁, the 5-qubit system is in the state

$$\begin{matrix}{\tilde{ρ}}_{{m}_{1} , a} = {P}_{succ , 1}^{BPQM} \cdot C {\tilde{ρ}}_{\pm , b}^{( {m}_{1} )} {\vert}_{{\hat{x}}_{1} = {x}_{1}} {C}^{†} + ( 1 - {P}_{succ , 1}^{BPQM} ) \cdot & ( 75 ) \\ {C {\tilde{ρ}}_{\pm , b}^{( {m}_{1} )} {\vert}_{{\hat{x}}_{1} \neq {x}_{1}} {C}^{†} = \vert {m}_{1} θ 〉 〈 {m}_{1} θ \vert}_{1} ⊗ [ W W ] {( {\hat{x}}_{1} )}_{23} ⊗ & \\ [ W W ] {( {\hat{x}}_{1} )}_{45} + {p}_{0}^{2} [ 0.5 ( 1 + sin ) - & \\ {{{1 ] \vert {m}_{1} θ 〉 〈 {m}_{1} θ \vert}_{1} ⊗ \vert {Γ}_{{\hat{x}}_{1}} 〉 〈 {Γ}_{{\hat{x}}_{1}} \vert}_{23} ⊗ \vert {Γ}_{{\hat{x}}_{1}} 〉 〈 {Γ}_{{\hat{x}}_{1}} \vert}_{45} & \end{matrix}$$

$${{{+ ( 1 - {P}_{succ , 1}^{BPQM} ) \cdot \vert {m}_{1} θ 〉 〈 {m}_{1} θ \vert}_{1} ⊗ \vert {Γ}_{{\hat{x}}_{1}} 〉 〈 {Γ}_{{\hat{x}}_{1}} \vert}_{23} ⊗ \vert {Γ}_{{\hat{x}}_{1}} 〉 〈 {Γ}_{{\hat{x}}_{1}} \vert}_{45} \qquad ( 76 )$$

$${= \vert {m}_{1} θ 〉 〈 {m}_{1} θ \vert}_{1} ⊗ [ W W ] {( {\hat{x}}_{1} )}_{23} ⊗ [ W W ] {( {\hat{x}}_{1} )}_{45} , \qquad ( 77 )$$

since P_{succ,1}^{BPQM}=p₀²·0.5(1+sin [symbol] )+(1−p₀²).

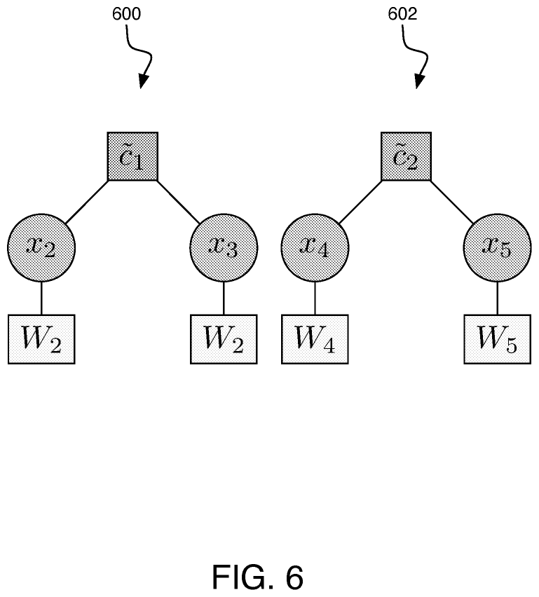

At this point, we have decoded \hat{x}₁=0 if m₁=+ and \hat{x}₁=1 if m₁=−. We can absorb the value of \hat{x}₁ in the FG by updating the parity checks c₁ and c₂ to impose x₂⊕x₃=\hat{x}₁ and x₄⊕x₅=\hat{x}₁, respectively. Now we have two disjoint FGs as shown in FIG. 6. It suffices to decode x₂ and x₄ since \hat{x}₃=\hat{x}₂⊕\hat{x}₁ and \hat{x}₅=\hat{x}₄⊕\hat{x}₁. Also, due to symmetry, it suffices to analyze the success probability of decoding x₂ (resp. x₄) and x₃ (resp. x₅). For this reduced FG, we need to split \tilde{ρ}ₘ_{₁}_{,a} into two density matrices corresponding to the hypotheses x₂=0 and x₂=1. If we revisit the density matrices ρ₁⁽⁰⁾ and ρ₁⁽¹⁾, we observe that the 5-qubit system at the channel output is exactly ½ρ₁⁽⁰⁾+½ρ₁⁽¹⁾. Hence, for x₂, we accordingly split [W [symbol] W](\hat{x}₁)₂₃ in \tilde{ρ}ₘ_{₁}_{,a} and arrive at the two hypotheses states

\tilde{Φ}ₓ_{₂}_{=\hat{x}}_{₁}(\hat{x}₁)=|m₁θ [symbol] m₁θ|₂⊗|θ [symbol] θ|₃⊗[W [symbol] W](\hat{x}₁)₄₅, (78)

\tilde{Φ}ₓ_{₂}_{≠\hat{x}}_{₁}(\hat{x}₁)=|−m₁θ [symbol] −m₁θ|₂⊗|−θ [symbol] −θ|₃⊗[W [symbol] W](\hat{x}₁)₄₅, (79)

We note, however, that the success probability we derive for bits 2-5 turns out to be significantly higher than the quantum optimal scheme for each bit at the channel output. This indicates that the state discrimination problem for bit 2 discussed above is more ideal than the actual problem in hand. Hence, next we analyze the true state discrimination problem for bit 2 (or 4).

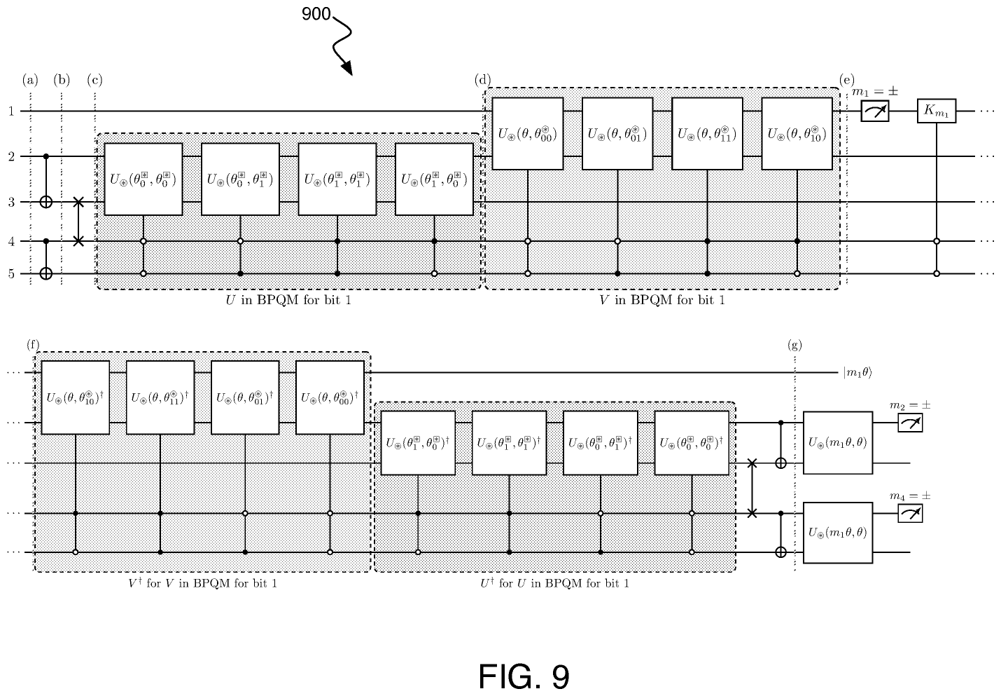

At the channel output, it is clear that the optimal strategy to decode bit 2 is to perform the Helstrom measurement that distinguishes between ρ₂⁽⁰⁾ and ρ₂⁽¹⁾. However, since we performed BPQM operations to decode bit 1 first, these two density matrices would have evolved through that process. Therefore, the correct analysis is to derive the resulting states and then subject them to the BPQM strategy for decoding bit 2 that was discussed above. For simplicity, we only track the density matrix ρ₂⁽⁰⁾ through the different stages in FIG. 7. In FIG. 9 we provide the full expanded BPQM circuit for decoding all bits, and this can be turned into a circuit composed of standard quantum operations by using the decompositions in FIG. 8A and FIG. 8B. The corresponding states for ρ₂⁽¹⁾ can easily be ascertained from these.

It will be convenient to express

½|θ [symbol] θ|₂⊗|θ [symbol] θ|₃=[W [symbol] W](0)₂₃−½|−θ [symbol] −θ|₂⊗|−θ [symbol] −θ|₃, (80)

½|θ [symbol] θ|₂⊗|−θ [symbol] −θ|₃=[W [symbol] W](1)₂₃−½|−θ [symbol] −θ|₂⊗|θ [symbol] θ|₃. (81)

For brevity, we will use the notation CXᵢⱼ:=CNOT_{i→j} and Swap₃₄:=CX₃₄CX₄₃CX₃₄. Then we can write

$$\begin{matrix}{{{{ρ}_{2 , a}^{( 0 )} = \frac{1}{2} \vert θ 〉 〈 θ \vert}_{1} ⊗ \vert θ 〉 〈 θ \vert}_{2} ⊗ \vert θ 〉 〈 θ \vert}_{3} ⊗ [ W W ] {( 0 )}_{45} & ( 82 ) \\ {{{+ \frac{1}{2} \vert - θ 〉 〈 - θ \vert}_{1} ⊗ \vert θ 〉 〈 θ \vert}_{2} ⊗ \vert - θ 〉 〈 - θ \vert}_{3} ⊗ [ W W ] {( 1 )}_{45} , & ( 83 )\end{matrix}$$

$$\begin{matrix}{{{{ρ}_{2 , b}^{( 0 )} = \vert θ 〉 〈 θ \vert}_{1} ⊗ [ {\sum }_{j = 0 , 1} {p}_{j} \vert 〉 〈 \vert}_{2} ⊗ \vert j 〉 〈 j \vert}_{3} - & ( 84 ) \\ {\frac{1}{2} {CX}_{23} \vert - θ , - θ 〉 〈 - θ , - θ \vert}_{23} {CX}_{23} ] & \\ {{⊗ [ {\sum }_{k = 0 , 1} {p}_{k} \vert 〉 〈 \vert}_{4} ⊗ \vert k 〉 〈 k \vert}_{5} ] & \\ {+ \vert - θ 〉 〈 - θ \vert}_{1} ⊗ [ {\sum }_{j = 0 , 1} {p}_{j} \vert - 〉 〈 - & \\ {{{\vert}_{2} ⊗ \vert j 〉 〈 j \vert}_{3} - \frac{1}{2} {CX}_{23} \vert - θ , θ 〉 〈 - θ , θ \vert}_{23} {CX}_{23} ] & \\ {{⊗ [ {\sum }_{k = 0 , 1} {p}_{k} \vert - 〉 〈 - \vert}_{4} ⊗ \vert k 〉 〈 k \vert}_{5} ] , & ( 85 )\end{matrix}$$

$$\begin{matrix}{{{ρ}_{2 , c}^{( 0 )} = \vert θ 〉 〈 θ \vert}_{1} ⊗ {\sum }_{j , k ∈ {\{ 0 , 1 \}}^{2}} {p}_{j} {p}_{k} \vert 〉 〈 \vert}_{2} ⊗ & ( 86 ) \\ {{{\vert 〉 〈 \vert}_{3} ⊗ \vert j 〉 〈 j \vert}_{4} ⊗ \vert k 〉 〈 k \vert}_{5} & \\ {{- \frac{1}{2} \vert θ 〉 〈 θ \vert}_{1} ⊗ {Swap}_{34} [ {CX}_{23} \vert - θ , - θ 〉 〈 - θ , - θ \vert}_{23} {CX}_{23} & \\ {{⊗ {\sum }_{k = 0 , 1} {p}_{k} \vert 〉 〈 \vert}_{4} ⊗ \vert k 〉 〈 k \vert}_{5} ] {Swap}_{34} & \\ {{+ \vert - θ 〉 〈 - θ \vert}_{1} ⊗ {\sum }_{j , k ∈ {\{ 0 , 1 \}}^{2}} {p}_{j} {p}_{k} \vert - 〉 〈 - \vert}_{2} ⊗ \vert - & \\ {{{〉 〈 - \vert}_{3} ⊗ \vert j 〉 〈 j \vert}_{4} ⊗ \vert k 〉 〈 k \vert}_{5} & \\ {{- \frac{1}{2} \vert - θ 〉 〈 - θ \vert}_{1} ⊗ {Swap}_{34} [ {CX}_{23} \vert - θ , θ 〉 〈 - θ , θ \vert}_{23} {CX}_{23} & ( 87 ) \\ {{⊗ {\sum }_{k = 0 , 1} {p}_{k} \vert - 〉 〈 - \vert}_{4} ⊗ \vert k 〉 〈 k \vert}_{5} ] {Swap}_{34} , & ( 88 )\end{matrix}$$

$$\begin{matrix}{{ρ}_{2 , e}^{( 0 )} = {\sum }_{j , k ∈ {\{ 0 , 1 \}}^{2}} {p}_{j} {p}_{k} \vert 〉 〈 \vert}_{1} ⊗ & ( 89 ) \\ {{{\vert 0 〉 〈 0 \vert}_{2} ⊗ \vert 0 〉 〈 0 \vert}_{3} ⊗ \vert jk 〉 〈 jk \vert}_{45} & \\ {{+ {\sum }_{j , k ∈ {\{ 0 , 1 \}}^{2}} {p}_{j} {p}_{k} \vert - 〉 〈 - \vert}_{1} ⊗ \vert 0 〉 〈 0 \vert}_{2} ⊗ & \\ {{{\vert 0 〉 〈 0 \vert}_{3} ⊗ \vert jk 〉 〈 jk \vert}_{45} - \frac{1}{2} VU \{ \vert θ 〉 〈 θ \vert}_{1} & \\ {⊗ {Swap}_{34} [ {CX}_{23} \vert - θ , θ 〉 〈 - θ , - θ \vert}_{23} {CX}_{23} ⊗ & \\ {{{\sum }_{k = 0 , 1} {p}_{k} \vert 〉 〈 \vert}_{4} ⊗ \vert k 〉 〈 k \vert}_{5} ] {Swap}_{34} & \\ {{+ \vert - θ 〉 〈 - θ \vert}_{1} ⊗ {Swap}_{34} [ {CX}_{23} \vert - θ , θ 〉 〈 - θ , θ \vert}_{23} {CX}_{23} & \\ {{⊗ {\sum }_{k = 0 , 1} {p}_{k} \vert - 〉 〈 - \vert}_{4} ⊗ \vert k 〉 〈 k \vert}_{5} ] {Swap}_{34} \} {U}^{†} {V}^{†} . & ( 90 )\end{matrix}$$

Next we make an X-basis measurement on the first qubit, and for convenience we assume that the measurement result is m₁=+. The analysis for m₁=− is very similar and follows by symmetry. We verified numerically that Tr[|+ [symbol] +|₁·ρ_{2,e}⁽⁰⁾]=0.5, which we might intuitively expect since ρ_{2,e}⁽⁰⁾ is the density matrix for x₂=0 and x₂ is independent from x₁. Since m₁=+, we follow the measurement with the conditional rotation M₊ in (35) to obtain

$$\begin{matrix}{{Φ}_{2 , {m}_{1} = +}^{( 0 )} = \frac{1}{0.5} [ {\sum }_{j , k ∈ {\{ 0 , 1 \}}^{2}} {p}_{j} {p}_{k} {\vert 〈 + 〉 \vert}^{2} \vert 〉 〈 \vert}_{1} ⊗ & ( 91 ) \\ {{{\vert 0 〉 〈 0 \vert}_{2} ⊗ \vert 0 〉 〈 0 \vert}_{3} ⊗ \vert jk 〉 〈 jk \vert}_{45} & \\ + \frac{{p}_{0}^{2} ( 1 - sin )}{2} \vert 〉 〈 \vert ⊗ & \\ {{{\vert 0 〉 〈 0 \vert}_{2} ⊗ \vert 0 〉 〈 0 \vert}_{3} ⊗ \vert 00 〉 〈 00 \vert}_{45} & \\ {{- \frac{1}{2} {M}_{+} \vert + 〉 〈 + \vert}_{1} VU {Λ}_{2}^{( 0 )} {U}^{†} {V}^{†} \vert + 〉 〈 + \vert}_{1} {M}_{+}^{†} ] , & \end{matrix}$$

$$\begin{matrix}{{{Λ}_{2}^{( 0 )} := \vert θ 〉 〈 θ \vert}_{1} ⊗ {Swap}_{34} [ {CX}_{23} \vert - θ , - θ 〉 〈 - θ , - θ \vert}_{23} {CX}_{23} & ( 92 ) \\ {{⊗ {\sum }_{k = 0 , 1} {p}_{k} \vert 〉 〈 \vert}_{4} ⊗ \vert k 〉 〈 k \vert}_{5} ] {Swap}_{34} & \\ {{+ \vert - θ 〉 〈 - θ \vert}_{1} ⊗ {Swap}_{34} [ {CX}_{23} \vert - θ , θ 〉 〈 - θ , θ \vert}_{23} {CX}_{23} & ( 93 ) \\ {{⊗ {\sum }_{k = 0 , 1} {p}_{k} \vert - 〉 〈 - \vert}_{4} ⊗ \vert k 〉 〈 k \vert}_{5} ] {Swap}_{34} . & ( 94 )\end{matrix}$$

This is the state at stage (f) in FIG. 7. Hence, for x₂=0, the density matrix we have when \hat{x}₁=0 and we reverse the BPQM operations on Φ_{2,m}_{₁}₌₊⁽⁰⁾ is

$${{{{\tilde{ρ}}_{2 , {m}_{1} = +}^{( 0 )} = \frac{1}{0.5} [ \vert θ 〉 〈 θ \vert}_{1} ⊗ [ W W ] {( 0 )}_{23} ⊗ [ W W ] {( 0 )}_{45} - \frac{1}{2} C {X}_{23} C {X}_{45} {Swap}_{34} {U}^{†} {V}^{†} M + \vert + 〉 〈 + \vert}_{1} VU {Λ}_{2}^{( 0 )} {U}^{†} {V}^{†} \vert + 〉 〈 + \vert}_{1} {M}_{+}^{†} {VU Swap}_{34} C {X}_{45} C {X}_{23} ] \qquad ( 95 )$$

This is the state at stage (g) in FIG. 7. So, this is the actual density matrix that BPQM encounters for x₂=0 after having estimated \hat{x}₁=0 . When compared with the earlier analysis, we observe numerically that this is close to \tilde{Φ}ₓ_{₂}_{=\hat{x}}_{₁}(\hat{x}₁) but is not exactly the same. For example, when θ=0.1π we find that ∥\tilde{p}_{2,m}_{₁}₌₊⁽⁰⁾−\tilde{Φ}ₓ_{₂}₌₀(0)∥_{Fro}=0.0542, where “Fro” denotes the Frobenius norm, and only two of the distinct entries differ (slightly). Similarly,

$${{{{\tilde{ρ}}_{2 , {m}_{1} = +}^{( 1 )} = \frac{1}{0.5} [ \vert θ 〉 〈 θ \vert}_{1} ⊗ [ W W ] {( 0 )}_{23} ⊗ [ W W ] {( 0 )}_{45} - \frac{1}{2} {CX}_{23} {CX}_{45} {Swap}_{34} {U}^{†} {V}^{†} {M}_{+} \vert + 〉 〈 + \vert}_{1} VU {Λ}_{2}^{( 1 )} {U}^{†} {V}^{†} \vert + 〉 〈 + \vert}_{1} \text{} {M}_{+}^{† \text{}} \text{} VU {Swap}_{34} {CX}_{45} {CX}_{23} ] , \qquad ( 96 )$$

$${{{{{{Λ}_{2}^{( 1 )} := \vert θ 〉 〈 θ \vert}_{1} ⊗ {Swap}_{34} [ {CX}_{23} \vert θ , θ 〉 〈 θ , θ \vert}_{23} {CX}_{23} ⊗ {\sum }_{k = 0 , 1} {p}_{k} \vert 〉 〈 \vert}_{4} ⊗ \vert k 〉 〈 k \vert}_{5} ] {Swap}_{34} + \vert - θ 〉 〈 - θ \vert}_{1} \qquad ( 97 )$$

$${{{⊗ {Swap}_{34} [ {CX}_{23} \vert θ , - θ 〉 〈 θ , - θ \vert}_{23} {CX}_{23} ⊗ {\sum }_{k = 0 , 1} {p}_{k} \vert - 〉 〈 - \vert}_{4} ⊗ \vert k 〉 〈 k \vert}_{5} ] {Swap}_{34} \qquad ( 98 )$$

However, we observe that ½\tilde{ρ}_{2,m}_{₁}₌₊⁽⁰⁾+½\tilde{ρ}_{2,m}_{₁}₌₊⁽¹⁾=½\tilde{Φ}ₓ_{₂}₌₀(0)+ 1/2 \tilde{Φ}ₓ_{₂}₌₁(0).

This explains that while the full density matrix \tilde{ρ}ₘ_{₁}_{,a} was correct, we had split it incorrectly to arrive at the two hypotheses \tilde{Φ}ₓ_{₂}_{=\hat{x}}_{₁}(\hat{x}₁) and \tilde{Φ}ₓ_{₂}_{≠\hat{x}}_{₁}(\hat{x}₁). Now, the Helstrom measurement that optimally distinguishes between \tilde{ρ}_{2,m}_{₁}₌₊⁽⁰⁾ and \tilde{ρ}_{2,m}_{₁}₌₊⁽¹⁾ only depends on

\tilde{ρ}_{2,m}_{₁}₌₊⁽⁰⁾−\tilde{ρ}_{2,m}_{₁}₌₊⁽¹⁾=A[Λ₂⁽¹⁾−Λ₂^{(0)]}A^{†}, A:=CX₂₃CX₄₅Swap₃₄U^{†}V^{†}M₊|+ [symbol] [symbol] +|₁VU. (99)

By symmetry of m₁=+ and m₁=−, the optimal success probability to decide bit 2 is given by

$${P}_{succ , 2}^{Hel} = \frac{1}{2} + \frac{1}{4} {‖ {\tilde{ρ}}_{2 , {m}_{1} = +}^{( 0 )} - {\tilde{ρ}}_{2 , {m}_{1} = +}^{( 1 )} ‖}_{1} = \frac{1}{2} + \frac{1}{4} {‖ A [ {Λ}_{2}^{( 1 )} - {Λ}_{2}^{( 0 )} ] {A}^{†} ‖}_{1} = \frac{1}{2} + \frac{1}{4} {‖ L ( {ρ}_{2}^{( 0 )} - {ρ}_{2}^{( 1 )} ) {L}^{†} ‖}_{1} , \qquad ( 100 )$$

$$L := {CX}_{23} {CX}_{45} {Swap}_{34} {U}^{†} {V}^{†} {M}_{+} \frac{{\vert + 〉 〈 + \vert}_{1}}{\sqrt{0.5}} VU {Swap}_{34} {CX}_{45} {CX}_{23} . \qquad ( 101 )$$

Since L is not unitary, we cannot directly apply the unitary invariance of the trace norm to conclude that there is no degradation in performance when compared to optimally distinguishing ρ₂^{(0) and ρ}₂⁽¹⁾ at the channel output. However, we observe numerically (even up to 12 significant digits) that the operations in L indeed ensure that ∥L(ρ₂⁽⁰⁾−ρ₂⁽¹⁾)L^{†}∥₁=∥ρ₂⁽⁰⁾−ρ₂⁽¹⁾∥₁. Moreover, we also observe that the BPQM operations for bit 2 achieve the same success probability, i.e., using the notation ±≡(−11)^{x}^{₂} we have

$${{P}_{s u c c , 2}^{B P Q M} = Tr [ ( {m}_{1} θ , θ ) {\tilde{ρ}}_{2 , {m}_{1}}^{( {x}_{2} )} {( {m}_{1} θ , θ )}^{†} \cdot \vert \pm 〉 〈 \vert}_{2} ] \qquad ( 102 )$$

$$= \frac{1}{2} + \frac{1}{4} {‖ L ( {ρ}_{2}^{( 0 )} - {ρ}_{2}^{( 1 )} ) {L}^{†} ‖}_{1} \qquad ( 103 )$$

$$= \frac{1}{2} + \frac{1}{4} {‖ {ρ}_{2}^{( 0 )} - {ρ}_{2}^{( 1 )} ‖}_{1} \qquad ( 104 )$$

$$= {P}_{s u c c , 2}^{He 1} . \qquad ( 105 )$$

Finally, our calculations clearly show that the overall block error rate of BPQM coincides with that of the quantum optimal joint Helstrom limit.

We can calculate the probability that the full codeword x is decoded correctly as

$${P}_{s u c c}^{B P Q M} = ℙ [ {\hat{x}}_{—} = {x ] = ℙ}_{—} [ \hat{{x}_{1}} = {x}_{1} ] \cdot ℙ [ \hat{{x}_{2}} = {x}_{2} \vert \hat{{x}_{1}} = {x}_{1} ] \cdot ℙ [ \hat{{x}_{4}} = {x}_{4} \vert \hat{{x}_{1}} = {x}_{1} , {\hat{x}}_{2} = {x}_{2} ] \qquad ( 106 )$$

$${= {P}_{succ , 1}^{B P Q M} \cdot {P}_{succ , 2}^{B P Q M} {\vert}_{{\hat{x}}_{1} = {x}_{1} = 0} \cdot {P}_{succ , 4}^{B P Q M} \vert}_{\begin{matrix}{\hat{x}}_{1} = {x}_{1} = 0 \\ {\hat{x}}_{2} = {x}_{2} = 0\end{matrix}} . \qquad ( 107 )$$

The first term in (107) is clearly P_{succ,1}^{BPQM}=P_{succ,1}^{Hel}. The second term, however, is different from P_{succ,2}^{BPQM}=P_{succ,2}^{Hel} because of the conditioning on x₁ being estimated correctly, whereas in the above analysis we had implicitly averaged over \hat{x}₁=x₁ and \hat{x}₁≠x₁. Nevertheless, we can use a similar strategy as above to derive an expression for the second term. Here, we want to condition on x₁ being estimated correctly, i.e., \hat{x}₁=x₁, and derive the hypothesis states for x₂ under this scenario. Similarly, for the third term, the additional conditioning on \hat{x}₂=x₂ makes it not equal to the second term, although x₂ and x₄ are placed symmetrically in the factor graph of the code. But it still holds that P_{succ,2}^{BPQM}|_{\hat{x}}_{₁}₌ₓ_{₁}₌₀=P_{succ,4}^{BPQM}|_{\hat{x}}_{₁}₌ₓ_{₁}₌₀. We perform these two analyses next and then combine them to calculate the full block success probability of BPQM.

We will first analyze the decoding of bit 2 conditioned on bit 1. Let (ρ₂⁽⁰⁰⁾,ρ₂⁽⁰¹⁾), (ρ₂⁽¹⁰⁾,ρ₂⁽¹¹⁾) be two pairs of hypothesis states for x₂, at the channel output, where the first pair is conditioned on x₁=0 and the second on x₁=1, and this information is known to the receiver. It is clear, for example, that ρ₂^{(0x}^{₂}⁾=|θ [symbol] θ|₁⊗|(−1)^{x}^{₂}θ [symbol] (−1)^{x}^{₂}θ|₂⊗|(−1)^{x}^{₂}θ [symbol] (−1)^{x}^{₂}θ|₃⊗[W [symbol] W](0)₄₅.

After similar calculations as before, we finally obtain

$${\tilde{σ}}_{2 , {m}_{1} = +}^{( 00 )} = \frac{1}{{P}_{succ , 1}^{He 1}} {CX}_{23} {CX}_{45} {Swap}_{34} {U}^{†} {V}^{†} \qquad ( 108 )$$

$${{{{[ 2 {\sum }_{j , k ∈ {\{ 0 , 1 \}}^{2}} {p}_{j} {p}_{k} \vert 〈 + \vert 〉 \vert}^{2} \vert 〉 〈 \vert}_{1} ⊗ \vert 0 〉 〈 0 \vert}_{2} ⊗ \vert 0 〉 〈 0 \vert}_{3} ⊗ \vert jk 〉 〈 jk {\vert}_{45} -$$

$${{{M}_{+} \vert + 〉 〈 + \vert}_{1} VU {\tilde{Λ}}_{2}^{( 0 )} {U}^{†} {V}^{†} \vert + 〉 〈 + \vert}_{1} {M}_{+}^{†} ] {VUSwap}_{34} {CX}_{45} {CX}_{23} , \qquad ( 109 )$$

$${{{\tilde{Λ}}_{2}^{( 0 )} := \vert θ 〉 〈 θ \vert}_{1} ⊗ {Swap}_{34} [ {CX}_{23} \vert - θ , - θ 〉 〈 - θ , - θ \vert}_{23} {CX}_{23} ⊗ \qquad ( 110 )$$

$${{{\sum }_{k = 0 , 1} {p}_{k} \vert 〉 〈 \vert}_{4} ⊗ \vert k 〉 〈 k \vert}_{5} ] {Swap}_{34} . \qquad ( 111 )$$

This is the state at stage (g) in FIG. 7. So, this is the actual density matrix that BPQM encounters for x₂=0 after having estimated correctly that \hat{x}₁=x₁=0 (and reversed the first set of operations). Similarly,

$${\tilde{σ}}_{2 , {m}_{1} = +}^{( 00 )} = \frac{1}{{P}_{succ , 1}^{He 1}} {CX}_{23} {CX}_{45} {Swap}_{34} {U}^{†} {V}^{†} \qquad ( 112 )$$

$${{{{[ 2 {\sum }_{j , k ∈ {\{ 0 , 1 \}}^{2}} {p}_{j} {p}_{k} \vert 〈 + \vert 〉 \vert}^{2} \vert 〉 〈 \vert}_{1} ⊗ \vert 0 〉 〈 0 \vert}_{2} ⊗ \vert 0 〉 〈 0 \vert}_{3} ⊗ \vert jk 〉 〈 jk {\vert}_{45} -$$

$${{{M}_{+} \vert + 〉 〈 + \vert}_{1} VU {\tilde{Λ}}_{2}^{( 1 )} {U}^{†} {V}^{†} \vert + 〉 〈 + \vert}_{1} {M}_{+}^{†} ] {VUSwap}_{34} {CX}_{45} {CX}_{23} , \qquad ( 113 )$$

$${{{\tilde{Λ}}_{2}^{( 1 )} := \vert θ 〉 〈 θ \vert}_{1} ⊗ {Swap}_{34} [ {CX}_{23} \vert θ , θ 〉 〈 θ , θ \vert}_{23} {CX}_{23} ⊗ \qquad ( 114 )$$

$${{{\sum }_{k = 0 , 1} {p}_{k} \vert 〉 〈 \vert}_{4} ⊗ \vert k 〉 〈 k \vert}_{5} ] {Swap}_{34} .$$

The Helstrom measurement that optimally distinguishes between \tilde{σ}_{2,m}_{₁}₌₊⁽⁰⁰⁾ and \tilde{σ}_{2,m}_{₁}₌₊⁽⁰¹⁾ achieves the success probability

$${{P}_{succ , 2}^{He 1} \vert}_{{\hat{x}}_{1} = {x}_{1} = 0} = \frac{1}{2} + \frac{1}{4} {‖ {\tilde{σ}}_{2 , {m}_{1} = +}^{( 00 )} - {\tilde{σ}}_{2 , {m}_{1} = +}^{( 01 )} ‖}_{1} \qquad ( 115 )$$

$$= \frac{1}{2} + \frac{1}{4 {P}_{succ , 1}^{He 1}} {‖ A [ {\tilde{Λ}}_{2}^{( 1 )} - {\tilde{Λ}}_{2}^{( 0 )} ] {A}^{†} ‖}_{1} . \qquad ( 116 )$$

We verified numerically that the final processing of BPQM, after (g) in FIG. 7, also achieves the same success probability, i.e.,

$${P}_{succ , 2}^{B P Q M} {\vert}_{{\hat{x}}_{1} = {x}_{1} = 0} = Tr [ ( θ , θ ) ‖ {\tilde{σ}}_{2 , {m}_{1} = +}^{( 0 {x}_{2} )} {( θ , θ )}^{†} \cdot \vert {( - 1 )}^{{x}^{2}} {\vert}_{2} ] \qquad ( 117 )$$

$$= \frac{1}{2} + \frac{1}{4 {P}_{succ , 1}^{He 1}} {‖ A [ {\tilde{Λ}}_{2}^{( 1 )} - {\tilde{Λ}}_{2}^{( 0 )} ] {A}^{†} ‖}_{1} \qquad ( 118 )$$

$$= {P}_{succ , 1}^{He 1} {\vert}_{{\hat{x}}_{1} = {x}_{1} = 0} . \qquad ( 119 )$$

Using a similar procedure as above, we can verify the analogous result for x₂ conditioned on x₁=1 and \hat{x}₁=x₁=1.

Next, we will analyze the decoding of bit 4 conditioned on bits 1 and 2. For convenience, let us assume that x₁=x₂=0 in the transmitted codeword. Note that, due to symmetry, this choice will not affect the analysis and the final probability of success for x₄ conditioned on correct estimation of x₁ and x₂ will be independent of this fixed choice. Then, at the channel output, the candidate states for x₄ are given by

ρ₄^{(00x}^{₄}⁾=|θ [symbol] θ|₁⊗|θ [symbol] θ|₂⊗|θ [symbol] θ|₃⊗|(−1)^{x}^{₄}θ [symbol] (−1)^{x}^{₄}θ|₄⊗|(−1)^{x}^{₄}θ [symbol] (−1)^{x}^{₄}θ|₅. (120)

Let U₁=VUSwap₃₄CX₄₅CX₂₃ and ρ_{4,1}^{(00x}^{₄}⁾=U₁p₄^{(00x}^{₄}⁾U₁^{†}. If p_{1,4}^{(00x}^{₄}⁾=Tr[|+ [symbol] +|₁·ρ_{4,1}^{(00x}^{₄}⁾] the probability of measuring x₁=0, then conditioned on this correct measurement we arrive at the following candidate states after the next set of BPQM operations:

$${ρ}_{4 , 2}^{( 00 {x}_{4} )} = \text{} \frac{{U}_{2} \cdot {ρ}_{4 , 1}^{( 00 {x}_{4} )} {U}_{2}^{†}}{{p}_{1 , 4}^{( 00 {x}_{4} )}} , {U}_{2} := \qquad ( 121 )$$

$${{( θ , θ )}_{45} {( θ , θ )}_{23} {CX}_{23} {CX}_{45} {Swap}_{34} {U}^{†} {V}^{†} {M}_{+} \vert + 〉 〈 + \vert}_{1} .$$

If p_{2,4}^{(00x}^{₄}⁾=Tr[|+ [symbol] +|₂·ρ_{4,2}^{(00x}^{₄}⁾] is the probability of measuring x₂=0, conditioned on \hat{x}₁=x₁, then conditioned on this correct measurement we arrive at the following candidate states after the x₂ measurement:

$${ρ}_{4 , 2}^{( 00 {x}_{4} )} = \frac{\vert + 〉 〈 + {\vert}_{2} \cdot {ρ}_{4 , 1}^{( 00 {x}_{4} )} \vert + 〉 〈 + {\vert}_{2}}{{ρ}_{2 , 4}^{( 00 {x}_{4} )}} . \qquad ( 122 )$$

Therefore, any measurement that optimally distinguishes between x₄=0 and x₄=1 conditioned on \hat{x}₁=x₁ and \hat{x}₂=x₂ must satisfy the same probability of success as the Helstrom measurement on (ρ_{4,3}⁽⁰⁰⁰⁾,ρ_{4,3}⁽⁰⁰¹⁾). We verified that measuring the 4th qubit in the X basis on ρ_{4,3}^{(00x}^{₄}⁾ indeed satisfies this and hence BPQM is optimal in estimating x₄ conditioned on estimating x₁ and x₂ correctly, i.e.,

$${{P}_{succ , 4}^{B P Q M} \vert}_{\begin{matrix}{\hat{x}}_{1} = {x}_{1} = 0 \\ {\hat{x}}_{2} = {x}_{2} = 0\end{matrix}} = Tr [ {ρ}_{4 , 3}^{( 00 {x}_{4} )} \cdot \vert {( - 1 )}^{{x}_{4}} 〉 〈 {( - 1 )}^{{x}_{4}} {\vert}_{4} ] \qquad ( 123 )$$

$$= \frac{1}{2} + \frac{1}{4} {‖ {ρ}_{4 , 3}^{( 000 )} - {ρ}_{4 , 3}^{( 001 )} ‖}_{1} \qquad ( 124 )$$

$$= {P}_{succ , 4}^{He 1} {\vert}_{\begin{matrix}{\hat{x}}_{1} = {x}_{1} = 0 \\ {\hat{x}}_{2} = {x}_{2} = 0\end{matrix}} . \qquad ( 125 )$$

However, we also observe that

$${{{{{P}_{succ , 4}^{B P Q M} \vert}_{\begin{matrix}{\hat{x}}_{1} = {x}_{1} = 0 \\ {\hat{x}}_{2} = {x}_{2} = 0\end{matrix}} = {P}_{succ , 4}^{He 1} \vert}_{\begin{matrix}{\hat{x}}_{1} = {x}_{1} = 0 \\ {\hat{x}}_{2} = {x}_{2} = 0\end{matrix}} \neq {P}_{succ , 2}^{He 1} \vert}_{{\hat{x}}_{1} = {x}_{1} = 0} = {P}_{succ , 2}^{BPQM} \vert}_{{\hat{x}}_{1} = {x}_{1} = 0} = {P}_{succ , 4}^{BPQM} {\vert}_{{\hat{x}}_{1} = {x}_{1} = 0} = {P}_{succ , 4}^{He 1} {\vert}_{{\hat{x}}_{1} = {x}_{1} = 0} . \qquad ( 126 )$$

Therefore, overall the BPQM success probability is given by

$${P}_{s u c c}^{B P Q M} = ℙ [ {\hat{x}}_{—} = {x ] = ℙ}_{—} [ \hat{{x}_{1}} = {x}_{1} ] \cdot ℙ [ \hat{{x}_{2}} = {x}_{2} \vert \hat{{x}_{1}} = {x}_{1} ] \cdot ℙ [ \hat{{x}_{4}} = {x}_{4} \vert \hat{{x}_{1}} = {x}_{1} , {\hat{x}}_{2} = {x}_{2} ] \qquad ( 127 )$$

$${= {P}_{succ , 1}^{B P Q M} \cdot {P}_{succ , 2}^{B P Q M} {\vert}_{{\hat{x}}_{1} = {x}_{1} = 0} \cdot {P}_{succ , 4}^{B P Q M} \vert}_{\begin{matrix}{\hat{x}}_{1} = {x}_{1} = 0 \\ {\hat{x}}_{2} = {x}_{2} = 0\end{matrix}} \qquad ( 128 )$$

$$= {P}_{succ , 1}^{He 1} ( \frac{1}{2} + \frac{1}{4 {P}_{succ , 1}^{He 1}} {‖ A [ {\tilde{Λ}}_{2}^{( 1 )} - {\tilde{Λ}}_{2}^{( 0 )} ] {A}^{†} ‖}_{1} ) \qquad ( 129 )$$

$$( \frac{1}{2} + \frac{1}{4} {‖ {ρ}_{4 , 3}^{( 000 )} - {ρ}_{4 , 3}^{( 001 )} ‖}_{1} )$$

$$\neq {{P}_{succ , 1}^{He 1} ( \frac{1}{2} + \frac{1}{4 {P}_{succ , 1}^{He 1}} {‖ A [ {\tilde{Λ}}_{2}^{( 1 )} - {\tilde{Λ}}_{2}^{( 0 )} ] {A}^{†} ‖}_{1} )}^{2} . \qquad ( 130 )$$

This success probability exactly equals the value from the closed-form expression one obtains using the fact that the square root measurement (SRM) is optimal for channel coding over the pure-state channel:

$${P}_{succ}^{SRM} = {( {\sum }_{h ∈ {ℤ}_{2}^{k}} \sqrt{\frac{\hat{s} ( h )}{{2}^{k / 2}}} \sqrt{\frac{1}{{2}^{k}}} )}^{2} , \qquad ( 131 )$$

$$\frac{1}{{2}^{k / 2}} \hat{s} ( h ) := {\sum }_{z ∈ {y}_{h} ⊕ {C}^{⊥}} {{p}^{{w}_{H} ( z )} ( 1 - p )}^{{w}_{H} ( z )} ; {\sum }_{h ∈ {ℤ}_{2}^{k}} \frac{\hat{s} ( h )}{{2}^{k / 2}} = 1 , \qquad ( 132 )$$

where yₕ is any vector in the coset of [symbol] ^{⊥} corresponding to h∈ [symbol] ₂^{k}. Alternatively, one can also use the Yuen-Kennedy-Lax (YKL) conditions to derive the optimal error rates.

For example, let us pick θ=0.05π which corresponds to the mean photon number per mode N≈0.00619. Then the optimal error probability from the SRM-based closed-form expression is 0.758171401618323 up to numerical precision. Similarly, the density-matrix based expression (129) produces the number 0.758171401618325 whose small difference can be attributed to numerical error. Furthermore, we have

$${P}_{succ , 1}^{BPQM} \approx 0.5889 , {P}_{succ , 2}^{BPQM} {\vert}_{{\hat{x}}_{1} = {x}_{1} = 0} \approx 0.6425 , {P}_{succ , 4}^{BPQM} {\vert}_{\begin{matrix}{\hat{x}}_{1} = {x}_{1} = 0 \\ {\hat{x}}_{2} = {x}_{2} = 0\end{matrix}} \approx 0.639 . \qquad ( 133 )$$

Note that P_{succ,2}^{BPQM}|_{\hat{x}}_{₁}₌ₓ_{₁}₌₀=P_{succ,4}^{BPQM}|_{\hat{x}}_{₁}₌ₓ_{₁}₌₀ but the additional conditioning on \hat{x}₂=x₂ makes a difference for x₄. The overall bit error probabilities for the 5 bits are given by

P_{err,1}^{BPQM}=1−P_{succ,1}^{BPQM}≈0.411, P_{err,i}^{BPQM}≈0.4160, i∈{2,3,4,5}. (134)

To check simulation results averaged over B=10⁶ codeword transmissions, we set the confidence level to be 1−α=0.98 and calculate the accuracy β of the error estimate. These quantities are related as

$$B = \frac{1}{p} {( \frac{{Q}^{- 1} ( α / 2 )}{β} )}^{2} , \qquad ( 135 )$$

where Q(⋅) is the “Q function” of the Gaussian distribution and p is the true error probability we are trying to estimate (numerically).
1. For the block error rate, p≈0.7582, we obtain β≈0.2671% which means the answer is in the window [0.7561, 0.7602]. The simulation produced the value 0.7573 which is well within this window. When we used only B=10⁵ codeword transmissions we obtained the value 0.7558. For this setting, again with 98% confidence, the window for β≈0.8448% is [0.7518, 0.7646], so the simulation result is well within this window.
2. For x₁, the result is well within β≈0.3629% from the actual number p≈0.4111 since the window is [0.4096, 0.4126] and the simulation gives 0.4111.
3. For x₂ through x₅ (which all have the same overall error probability), the results are well within β≈0.3606% from the actual number p=0.4160 since the window is [0.4145, 0.4175] and the simulation yields 0.4163 for x₂, 0.4168 for x₃, 0.4150 for x₄, and 0.4163 for x₅.

We also observe that if we ignore the coherent rotation after measuring x₁, then the success probabilities of the remaining bits decrease significantly to

$${P}_{succ , 2}^{BPQM} {\vert}_{{\tilde{x}}_{1} = {x}_{1} = 0} \approx 0.609 , {P}_{succ , 4}^{BPQM} {\vert}_{\begin{matrix}{\hat{x}}_{1} = {x}_{1} = 0 \\ {\hat{x}}_{2} = {x}_{2} = 0\end{matrix}} \approx 0.6161 .$$

Due to this, the overall block error rate increases to roughly 0.7790. Therefore, it is clear that the coherent rotation plays a non-trivial role in the optimality of BPQM.

The above analyses demonstrate that even though the measurement for each bit is irreversible, BPQM still decides each bit optimally in this 5-bit example code. In particular, the order in which the bits are decoded does not seem to affect the performance. This needs to be studied further and we need to analyze if BPQM always achieves the codeword Helstrom limit for all codes with tree factor graphs. We emphasize that, while in classical BP there is no question of ordering and one makes hard decisions on all the bits simultaneously after several BP iterations, it appears that quantum BP always has a sequential nature due to the unitarity of operations and the no-cloning theorem. This resembles “successive-cancellation” type decoders more than BP. Due to these facts, we expect that extending classical ideas for analyzing BP, such as density evolution, will require some caveats in the quantum setting.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for processing a signal comprising a plurality of codewords associated with a set of codewords, each codeword comprising a plurality of symbols associated with a symbol constellation, the method comprising:
mapping quantum states associated with symbols of a particular codeword of the signal to a plurality of input qubits; and
applying quantum operations to the input qubits according to a quantum circuit for decoding the signal;
wherein the quantum operations comprise:
a plurality of controlled unitary multi-qubit operations performed on two or more qubits in a first set of qubits controlled based on two or more qubits in a second set of qubits,
an initial quantum measurement performed on an initially measured qubit in the first set of qubits,
at least one controlled unitary single-qubit operation performed on a post-measurement state associated with the initially measured qubit, and
a plurality of quantum operations that invert at least a portion of the operations in the plurality of controlled unitary multi-qubit operations.

2. The method of claim 1, wherein the controlled unitary single-qubit operation performed on the post-measurement state associated with the initially measured qubit is controlled based on at least two of the qubits in the second set of qubits.

3. The method of claim 2, wherein the controlled unitary single-qubit operation applies one of two potential rotations that is determined based at least in part on a result of the initial quantum measurement.

4. The method of claim 2, wherein the plurality of quantum operations that invert at least a portion of the operations in the plurality of controlled unitary multi-qubit operations operate on a result of the controlled unitary single-qubit operation.

5. The method of claim 4, wherein the plurality of controlled unitary multi-qubit operations include a first unitary multi-qubit operation that operates on all of the two or more qubits except for the initially measured qubit in the first set of qubits, and the quantum operations that invert at least a portion of the operations in the plurality of controlled unitary multi-qubit operations include a second unitary multi-qubit operation that operates on the same qubits as the first unitary multi-qubit operation.

6. The method of claim 5, wherein the second unitary multi-qubit operation corresponds to a Hermitian adjoint of the first unitary multi-qubit operation.

7. The method of claim 1, further comprising a plurality of multi-qubit operations performed on two or more qubits in a third set of qubits that includes qubits from the first and second sets of qubits, after the plurality of quantum operations that invert at least a portion of the operations in the plurality of controlled unitary multi-qubit operations.

8. The method of claim 7, further comprising a plurality of quantum measurements performed on two or more qubits other than the initially measured qubit to provide information used for decoding the particular codeword of the signal.

9. The method of claim 1, further comprising generating the quantum circuit based at least in part on the set of codewords.

10. The method of claim 1, wherein the initial quantum measurement comprises a quantum nondemolition measurement that determines information from the initially measured qubit and propagates the post-measurement state associated with the initially measured qubit after the quantum nondemolition measurement.

11. The method of claim 1, wherein the initial quantum measurement comprises a destructive measurement that determines classical information from the initially measured qubit and prepares a quantum state of an ancilla qubit based on the classical information to provide the post-measurement state associated with the initially measured qubit.

12. The method of claim 1, wherein all of the input qubits mapped from the quantum states associated with the symbols of the particular codeword of the signal are stored before any of the quantum operations are applied to the input qubits.

13. The method of claim 1, wherein information used for decoding the particular codeword of the signal is provided from the quantum operations before any quantum operations are applied to any input qubits mapped from quantum states associated with symbols of any codeword received from the signal after the particular codeword was received.

14. The method of claim 1, wherein mapping the quantum states associated with symbols of the particular codeword of the signal to the plurality of input qubits comprises converting optical qubits to qubits represented by a quantum state of a trapped atom or ion, or a quantum state of a superconducting circuit, or a nitrogen-vacancy center.

15. The method of claim 14, wherein the optical qubits comprise output photons that result from nonlinear optical interactions between a first set of input photons included in the signal and a second set of input photons received from an entangled photon pair source.

16. The method of claim 15, wherein the first set of input photons were derived from photons received from the entangled photon pair source before being encoded as symbols of the particular codeword of the signal.

17. The method of claim 1, wherein the particular codeword is associated with a factor graph and the quantum circuit is arranged to perform a belief propagation procedure for decoding the particular codeword of the signal.

18. The method of claim 17, wherein the belief propagation procedure includes quantum message passing implemented using the quantum circuit.

19. The method of claim 18, wherein the belief propagation procedure includes reducing the factor graph into one or more disjoint factor graphs resulting from parity checks associated with the symbol constellation.

20. One or more non-transitory machine-readable media comprising instructions that, when executed by a system comprising a quantum processor, cause the system to perform operations comprising:
configuring the quantum processor for executing a quantum circuit;
receiving a plurality of input qubits corresponding to quantum states associated with symbols of a particular codeword of a signal comprising a plurality of codewords associated with a set of codewords, each codeword comprising a plurality of symbols associated with a symbol constellation; and
applying quantum operations to the input qubits according to the quantum circuit for decoding the signal;
wherein the quantum operations comprise:
a plurality of controlled unitary multi-qubit operations performed on two or more qubits in a first set of qubits controlled based on two or more qubits in a second set of qubits,
an initial quantum measurement performed on an initially measured qubit in the first set of qubits,
at least one controlled unitary single-qubit operation performed on a post-measurement state associated with the initially measured qubit, and
a plurality of quantum operations that invert at least a portion of the operations in the plurality of controlled unitary multi-qubit operations.

21. An apparatus comprising:
a signal interface configured to map quantum states associated with symbols of a particular codeword of a signal to a plurality of input qubits, the signal comprising a plurality of codewords associated with a set of codewords, each codeword comprising a plurality of symbols associated with a symbol constellation; and
a quantum processor configured to apply quantum operations to the input qubits according to a quantum circuit for decoding the signal;
wherein the quantum operations comprise:
a plurality of controlled unitary multi-qubit operations performed on two or more qubits in a first set of qubits controlled based on two or more qubits in a second set of qubits,
an initial quantum measurement performed on an initially measured qubit in the first set of qubits,
at least one controlled unitary single-qubit operation performed on a post-measurement state associated with the initially measured qubit, and
a plurality of quantum operations that invert at least a portion of the operations in the plurality of controlled unitary multi-qubit operations.

22. The apparatus of claim 21, wherein the signal interface is configured to receive the quantum states from an optical communications channel.

23. The apparatus of claim 22, wherein the optical communications channel comprises an optical fiber.

24. The apparatus of claim 21, wherein the signal interface is configured to receive the quantum states from a quantum register that is coupled to a control module that is configured to apply quantum gate operations among quantum states stored in the quantum register.
